(19) United States
(12) Patent Application Publication
(10) Pub. No.: US 2001/0034663 A1
(43) Pub. Date: Oct. 25, 2001

(54) Electronic contract broker and contract market maker infrastructure

(76) Inventors: Eugene Teveler, Owings Mills, MD (US); Vadim Kaydanov, Laurel, MD (US)

Correspondence Address: Richard C. Litman, LITMAN LAW OFFICES, LTD., P.O. Box 15035, Arlington, VA, 22215, US

(21) Appl. No.: 09/788,417

(22) Filed: Feb. 21, 2001

Related U.S. Application Data
(60) Provisional application No. 60/184,314, filed on Feb. 23, 2000.

(51) Int. Cl. G06F 17/60

(52) U.S. Cl. 705/26; 705/37; 705/27

(57) ABSTRACT

The electronic contract broker and contract market maker is a system and method for providing a buyer with a discount on the purchase of commodities, such as goods, services, or capital, by tying the original transaction to the long term purchase of goods or services from one or more commodity providers. The system is implemented via a distributed computer network, such as the Internet, or a proprietary network. A buyer selects the amount of the discount in the limits defined by the system, which presents the buyer with goods and services in one or more buyer-selected categories to purchase over time, and the buyer contracts with the system to make the time purchases. The system advances the discount to the original merchant, and bundles the contractual commitments of several buyers in a given category into software objects which are auctioned to commodity providers over a distributed network.

### CROSS-REFERENCE TO RELATED APPLICATION

This application claims the benefit of U.S. Provisional Patent Application Ser. No. 60/184,314, filed Feb. 23, 2000.

### BACKGROUND OF THE INVENTION

1. Field of the Invention

The present invention relates to an electronic system and method for providing a discount on an original purchase of a product or service, or the extension of credit, by tying the original transaction to a contract to purchase goods or services from one or more commodity providers. The system is implemented on a distributed network, such as the Internet, and provides for the creation of a computer software object for each category of goods and services the buyer contracts to purchase, and for the creation of a computer software object which bundles the contractual commitments of a plurality of buyers to purchase goods and services in a given category, and subsequent auction of the contractual commitments to commodity providers over a distributed network.

2. Description of Related Art

Since the mid 1990's various e-commerce and e-tailer B2C and B2B companies employed various trading models to attract customers, and sell goods on the Internet. The essence of all employed models could be extracted and represented in graphical terms below. All market exchanges could be described in terms of interactions between buyers and sellers (various actors). The major actors in all of the models are:

the buyers (at least one)

original sellers (at least one)

secondary sellers (at least one)

secondary buyers (at least one)

distributors (at least one) that can be wholesalers or manufacturers

The original sellers are the merchants that originate the sales to the original buyers. The secondary sellers are merchants who sell items to the original or secondary buyers under certain conditions imposed on the buyers during first sale. Important parameters include interactions between actors, time parameters, the number of actors in each category, among other things.

Current market models are shown in FIGS. 27-32. A conventional Internet sales model is shown in FIG. 27 wherein one buyer interacts with one seller. The seller receives products from a variety of wholesalers. Most Internet e-tailers belong to this category. Neither aggregation nor bidding time is important for this pattern of trading. E-tailers can purchase/arrange goods from distributors online or via offline arrangements. Direct sales are a special category, wherein the seller is also a wholesaler/manufacturer. Ashford.com and eToys are good representations of this model.

A basic auction model is shown in FIG. 28. Multiple buyers bid for the same product presented on the Internet by a singular seller. Bidding time (Tbid) is important for this model, while aggregation time is not used in this pattern of trading. E-tailers can purchase/arrange goods from distributors online or via offline arrangements. Ebay.com represents this type of model where bids from a number of original buyers are accumulated over a period of bidding time (Tbid).

An aggregator model is shown in FIG. 29. Typical aggregators have arrangements with original merchants or collect buyers' requests for certain items. Aggregators then group together a number of buyers doing this grouping over a period of time (Tacc). Thus, aggregators may offer prices for selected items that are lower than retail prices. Mercata.com and ActBig.com are representative of this type of model.

A reverse-auction e-tailer model is shown in FIG. 30. An original seller presents products online or collects requests for certain items from an individual buyer. The buyer has the right to offer a price for the item/service presented by the original seller. This contract is then offered to a number of secondary sellers. Priceline.com, Respond.com, and other providers have utilized this system of trading.

A model for Internet access service bundling with computer sales is shown in FIG. 31. Original sellers, such as computer hardware resellers, offer a discount on their products if the buyer agrees to a purchase of a time-set service contract of Internet access. An example would be if Compaq.com offered $400 off a computer purchase with a 3-year Compuserve Internet Access service contract (note, however, that the purchaser is restricted to a particular Internet service provider, compuserve in this example, and does not have the option of selecting another ISP or another category of goods and services entirely to obtain the discount), or if Winbook.com offered a $400 rebate when the original buyer opens an E-Trade account. FIG. 32 illustrates the combination of the above described models.

The related art is represented by the following patents of interest.

U.S. Pat. No. 5,710,887, issued Jan. 28, 1998 to Chelliah et al., describes a system for electronic commerce which connects a plurality of customers with at least one supplier, allowing customers to obtain information on and order particular products and to edit the purchase order before submission. The system may provide for the supplier providing a discount, but does not describe tying the sale of one product to the sale of one or more secondary products, nor the bundling of multiple customer orders.

U.S. Pat. No. 5,794,219, issued Aug. 11, 1998 to S. J. Brown, teaches a method of pooling bids in an online auction by using bidding groups, each member of a bidding group submitting a bid together with identification of the bidding group, the bids being updated in real time.

U.S. Pat. No. 5,799,284, issued Aug. 25, 1998 to R. E. Bourquin, discloses a client-server software system which allows manufacturers or sellers to publish information about particular products on a computer network and permits clients to search the data and view the results. U.S. Pat. No. 5,825,881, issued Oct. 20, 1998 to B. Colvin, Sr., describes a network merchandising system with a database, a customer interface, a financial institution interface, and a virtual HTML store generator.

U.S. Pat. No. 5,873,071, issued Feb. 16, 1999 to Ferstenberg et al., describes a system for the exchange of financial commodities, such as equity securities, commodity futures, stock options, etc., and particularly with portfolios of financial commodities. U.S. Pat. No. 5,924,083, issued Jul. 13, 1999 to Silverman et al., teaches a distributed electronic system for trading in currencies, commodities, etc., which provides credit checks on parties to the proposed transaction, as well as all available offer and bid prices for trade instruments.

None of the above inventions and patents, taken either singly or in combination, is seen to describe the instant invention as claimed.

### SUMMARY OF THE INVENTION

The present invention is an electronic contract broker and contract market maker apparatus, method, and system for providing a buyer with a discount on an original purchase of a product or service, or for the extension of credit, by tying the original transaction to a contract for the long term purchase of one or more commodities, and the subsequent sorting of the contracts by the category of commodity and bundling the contractual commitment of a plurality of buyer contracts for auction to commodity providers. The system is implemented via a distributed computer network, such as the Internet, or a proprietary network. Commodity, as used herein, refers to any category of goods or services presented to a buyer to be purchased over a period of time in the amount of the contract. The buyer selects the amount of the above discount in the limits defined by the system. The purchase contract obligates the buyer to buy a certain amount of goods or services in one or more commodity categories, selected by the buyer, over a period of time. The time period described above is determined by the system and depends on the amount of the contractual obligation in a particular commodity category. Information provided by the system to the buyer in the purchase process is presented through various means. Three examples of such are a browser-enabled remote terminal, such as a personal computer connected to the Internet; a wireless personal digital assistant (PDA) or a web-enabled cellular phone; and a brick and mortar store located kiosk, where the kiosk acts as a remote terminal connected to the trading system owner through either a retailer's private network, the Internet, or directly to the trading system owner through a wireless remote access system.

The system presents different commodity categories for buyer's selection. Commodity categories can be as different as supercategories such as “supermarkets” and “department stores”, or business leasing such as “heavy machinery leasing”, or “natural gas delivery”, or the like. The system presents a list of vendors for each category to the buyer for information purposes. The buyer then selects a particular category, and the system determines the commodity vendor via an auction process bidding.

The system bundles together a number of buyers' contracts together into one contract package (bundled by categories, locations, and time periods). This data package is then automatically channeled onto an auction portion of the system through a secure distributed computer network, where commodity vendors can bid for such packages. The bidding can proceed remotely over the Internet through browser software on a personal workstation, over a virtual private network, through wireless devices, or through automated server-side processes.

Monetary transactions required for the system are described below. First, a buyer pays in full for the items/services purchased from an original merchant whether done via Internet, retail kiosk, or wireless devices, i.e., the buyer pays the discounted price to the original merchant in full and the electronic contract broker pays the amount of the discount to the original merchant after the buyer has contractually committed to purchase the commodities. The buyer pays the original merchant with a credit card or by using a line of credit from a bank (for a business buyer). Since the buyer may select more than one commodity category to purchase over a period of time, the system has to split a buyer-selected discount into multiple portions, each of which corresponds to one commodity category.

Second, to enable a selected discount, the buyer digitally signs an agreement with the system at the time of purchase. The signed agreement authorizes the trading system create a credit debt account in the buyer's name in the amount of the discount with authorization to enact a debt-balance transfer from the buyer's credit card or line of credit in the amount of the buyer-selected discount to the trading system backed third party online banking service in the event the buyer defaults on his contractual commitment to purchase commodities over the course of the agreed upon time period. A second balance transfer, if needed, would be done from the trading system to multiple commodity providers, each of one commodity category.

Thus, the buyer agrees to the creation of his/her debt balance in the amount equivalent of the original discount and the splitting of the debt in the amount of buyer-selected discount into multiple credit debts (the number of which equals the number of buyer-selected commodity categories). At the trading system electronic debt caching web site (at the application server level), the debt will be split into a number of debts, each of which corresponds to one commodity category purchase by the buyer. When the operations part of the dual operations/trading system generates SIMPLETs (simple trade object implemented as a software object) for each commodity category, the operations application software will calculate the monetary amount of each portion of discount for this particular commodity category. The system will later combine particular simplets with only portions of the buyer's debt (“discount debt”) into one COMPLET contract bundle.

After a COMPLET is auctioned to the commodity providers, a bid winner receives all of the information on credit balances for each SIMPLET. A bid winner will electronically transfer the amount of money of the winning bid to the trading system, which will at least cover the amount of the discount paid by the system to the original merchant's on the buyer's behalf. The debt balance in the size of the buyer-selected discount, together with authorization to charge the original buyer's credit card or line of credit, held by the trading system owner and after the auction by multiple commodity vendors, is considered by the system as a guarantee of future purchases of commodities in buyer-selected commodity categories over a period of time. All interactions between the buyer and the trading system servers are conducted as hypertext transfer protocol (HTTP) calls. Data exchange and synchronization between the original merchant and the trading system owner will use extended mark-up language (XML) described format over the HTTP calls. Interactions between commodity bidders and trading system owner's servers are done as HTTP calls. Again, data exchange is done in XML-format over the calls. All important communications between a merchant, a trading system owner, and commodity bidders, are public key encrypted.

Accordingly, it is a principal object of the invention to provide an electronic contract broker and contract market maker infrastructure in the form of an electronic system and method for providing a buyer with a discount for the purchase of a product or service, or for the extension of credit, by tying the original transaction to a contractual commitment to purchase commodities, such as goods or services, over a period of time, bundling the contractual commitments of a plurality of buyers into a software object, and auctioning the software object to commodity providers over a distributed network.

It is further an object of the invention to provide a method of allocating a discount advanced to a purchaser to a contractual commitment to purchase goods and services in a plurality of categories, apportioning the discount between categories, and creating a software object for each category.

Still another object of the invention is to bundle the software objects for a plurality of buyers in the same category into a single software object and auctioning the software object representing the contractual commitments of a plurality of buyers to commodity providers who provide the goods or services in the buyers locality.

A further object of the invention is to auction the contractual commitments of a plurality of buyers to purchase goods or services over an extended period of time, performing a credit check on each buyer before auctioning the contractual commitments in order to reduce the bidder's risk.

It is an object of the invention to provide improved elements and arrangements thereof in an electronic contract broker and contract market maker infrastructure for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 illustrates the overall computer architecture of an electronic contract broker and contract market maker infrastructure according to the present invention.

FIG. 2 illustrates the architectural overview of the Order Processing System (OPS) of an electronic contract broker and contract market maker infrastructure according to the present invention.

FIG. 3 illustrates the architectural overview of the Trading System (TS) of an electronic contract broker and contract market maker infrastructure according to the present invention.

FIGS. 4A and 4B illustrates the mechanism of discount selection by a buyer in an electronic contract broker and contract market maker infrastructure according to the present invention.

FIGS. 4C and 4D illustrates a universal trading system flowchart for portals and e-malls of an electronic contract broker and contract market maker infrastructure according to the present invention.

FIGS. 4E and 4F illustrates an OPS/TS interfacing flowchart between a merchant and a buyer in an electronic contract broker and contract market maker infrastructure according to the present invention.

FIG. 5 illustrates SIMPLET generation in OPS application software for an electronic contract broker and contract market maker infrastructure according to the present invention.

FIGS. 6A-6B illustrate the COMPLET generation algorithm for an electronic contract broker and contract market maker infrastructure according to the present invention.

FIGS. 7A-7B illustrate the statistical COMPLET analyzer algorithm for an electronic contract broker and contract market maker infrastructure according to the present invention.

FIGS. 8A-8B illustrate the registration process for commodity providers in an electronic contract broker and contract market maker infrastructure according to the present invention.

FIGS. 9A-9D illustrate the logic of the TS bidding process for an electronic contract broker and contract market maker infrastructure according to the present invention.

FIG. 10 illustrates the trading system's bidders-buyers association algorithm of an electronic contract broker and contract market maker infrastructure according to the present invention.

FIGS. 11A-11B illustrate the registration process for a commodity provider in an electronic contract broker and contract market maker infrastructure according to the present invention.

FIG. 12 illustrates the contract options trading preparation process in an electronic contract broker and contract market maker infrastructure according to the present invention.

FIG. 13 illustrates the retail kiosk architecture overview of the trading system of an electronic contract broker and contract market maker infrastructure according to the present invention.

FIGS. 14A-14B illustrate the retail kiosk data exchange process of an electronic contract broker and contract market maker infrastructure according to the present invention.

FIG. 15 illustrates the architecture of a universal portal with a trading system implementation of an electronic contract broker and contract market maker infrastructure according to the present invention that complements FIG. 4C and 4D.

FIG. 16 illustrates the double credit transfer of credit debt in the amount of a buyer-selected discount from the buyer to the trading system owner site and then to multiple commodity providers in an electronic contract broker and contract market maker infrastructure according to the present invention.

FIG. 17 illustrates the architecture of the trading system auctioning COMPLETs to the commodity providers associated with a commodity market exchange in an electronic contract broker and contract market maker infrastructure according to the present invention.

FIG. 18 is a screenshot showing a browser-enabled interface of a discount interface as presented to original buyers for an electronic contract broker and contract market maker infrastructure according to the present invention.

FIG. 19 is a screenshot showing the interface of FIG. 18 with a frame listing commodity providers for a particular commodity and location added to the display.

FIG. 20 is a screenshot showing a browser-enabled interface of a discount interface as presented to business buyers for an electronic contract broker and contract market maker infrastructure according to the present invention.

FIG. 21 is a screenshot showing a display interface for a particular trading system implementation for Internet portal stores and Internet malls (e-malls) according to the present invention.

FIG. 22 is a screenshot showing the display of FIG. 21 with a frame added providing a link to the Trading System of the present invention.

FIG. 23 is a screenshot showing a particular trading system interface for commodity bidders according to the present invention.

FIGS. 24A-24B illustrate the statistical COMPLET analyzer algorithm for an electronic contract broker and contract market maker infrastructure according to the present invention.

FIGS. 25A-25C illustrate the registration process for commodity providers in an electronic contract broker and contract market maker infrastructure according to the present invention.

FIGS. 26A-26B illustrate the logic of the TS bidding process for an electronic contract broker and contract market maker infrastructure according to the present invention.

FIG. 27 illustrates a conventional Internet sales model.

FIG. 28 illustrates a conventional basic auction model.

FIG. 29 illustrates a conventional aggregator model.

FIG. 30 illustrates a conventional reverse-auction e-tailer model.

FIG. 31 illustrates a conventional Internet access service bundling with computer sales model.

FIG. 32 illustrates a summary of FIGS. 27-31.

FIG. 33 is a block diagram of a typical personal computer which may be used as a server or work station in carrying out the present invention.

Similar reference characters denote corresponding features consistently throughout the attached drawings.

### DETAILED DESCRIPTION OF THE PREFERRED EMBODIMENTS

The present invention is an electronic contract broker and contract market maker apparatus, method, and system for providing a buyer with a discount on an original purchase of a product or service, or for the extension of credit, by tying the original transaction to a contract for the long term purchase of one or more commodities, and the subsequent sorting of the contracts by the category of commodity and bundling the contractual commitment of a plurality of buyer contracts for auction to commodity providers.

The system is implemented via a distributed computer network, such as the Internet, or a proprietary network. Commodity, as used herein, refers to any category of goods or services presented to a buyer to be purchased over a period of time in the amount of the contract. The buyer selects the amount of the above discount in the limits defined by the system. The purchase contract obligates the buyer to buy a certain amount of goods or services in one or more commodity categories, selected by the buyer, over a period of time. The time period described above is determined by the system and depends on the amount of the contractual obligation in a particular commodity category. Information provided by the system to the buyer in the purchase process is presented through various means. Three examples of such are a browser-enabled remote terminal, such as a personal computer connected to the Internet; a wireless personal digital assistant (PDA) or a web-enabled cellular phone; and a brick and mortar store located kiosk, where the kiosk acts as a remote terminal connected to the trading system owner through either a retailer's private network, the Internet, or directly to the trading system owner through a wireless remote access system.

The system presents different commodity categories for buyer's selection. Commodity categories can be as different as supercategories such as “supermarkets” and “department stores”, or business leasing such as “heavy machinery leasing”, or “natural gas delivery”, or the like. The system presents a list of vendors for each category to the buyer for information purposes. The buyer then selects a particular category, and the system determines the commodity vendor via an auction process bidding.

The system bundles together a number of buyers' contracts together into one contract package (bundled by categories, locations, and time periods). This data package is then automatically channeled onto an auction portion of the system through a secure distributed computer network, where commodity vendors can bid for such packages. The bidding can proceed remotely over the Internet through browser software on a personal workstation, over a virtual private network, through wireless devices, or through automated server-side processes.

Monetary transactions required for the system are described below. First, a buyer pays in full for the items/services purchased from an original merchant whether done via Internet, retail kiosk, or wireless devices, i.e., the buyer pays the discounted price to the original merchant in full and the electronic contract broker pays the amount of the discount to the original merchant after the buyer has contractually committed to purchase the commodities. The buyer pays the original merchant with a credit card or by using a line of credit from a bank (for a business buyer). Since the buyer may select more than one commodity category to purchase over a period of time, the system has to split a buyer-selected discount into multiple portions, each of which corresponds to one commodity category.

Second, to enable a selected discount, the buyer digitally signs an agreement with the system at the time of purchase. The signed agreement authorizes the trading system create a credit debt account in the buyer's name in the amount of the discount with authorization to enact a debt-balance transfer from the buyer's credit card or line of credit in the amount of the buyer-selected discount to the trading system backed third party online banking service in the event the buyer defaults on his contractual commitment to purchase commodities over the course of the agreed upon time period. A second balance transfer, if needed, would be done from the trading system to multiple commodity providers, each of one commodity category.

Thus, the buyer agrees to the creation of his/her debt balance in the amount equivalent of the original discount and the splitting of the debt in the amount of buyer-selected discount into multiple credit debts (the number of which equals the number of buyer-selected commodity categories). At the trading system electronic debt caching web site (at the application server level), the debt will be split into a number of debts, each of which corresponds to one commodity category purchase by the buyer. When the operations part of the dual operations/trading system generates SIMPLETs (simple trade object implemented as a software object) for each commodity category, the operations application software will calculate the monetary amount of each portion of discount for this particular commodity category. The system will later combine particular simplets with only portions of the buyer's debt (“discount debt”) into one COMPLET contract bundle.

After a COMPLET is auctioned to the commodity providers, a bid winner receives all of the information on credit balances for each SIMPLET. A bid winner will electronically transfer the amount of money of the winning bid to the trading system, which will at least cover the amount of the discount paid by the system to the original merchant's on the buyer's behalf. The debt balance in the size of the buyer-selected discount, together with authorization to charge the original buyer's credit card or line of credit, held by the trading system owner and after the auction by multiple commodity vendors, is considered by the system as a guarantee of future purchases of commodities in buyer-selected commodity categories over a period of time. All interactions between the buyer and the trading system servers are conducted as hypertext transfer protocol (HTTP) calls. Data exchange and synchronization between the original merchant and the trading system owner will use extended mark-up language (XML) described format over the HTTP calls. Interactions between commodity bidders and trading system owner's servers are done as HTTP calls. Again, data exchange is done in XML-format over the calls. All important communications between a merchant, a trading system owner, and commodity bidders, are public key encrypted.

The Internet comprises a large number of servers which are accessible by client computers, typically users of personal computers, through some private Internet access provider (such as Internet America) or an on-line service provider (such as America On-line, Prodigy, Compuserve, the Microsoft Network, and the like). Each of the client computers may run a browser, which is a known software tool used to access the servers via the access providers. A server operates a so-called web site which supports files in the form of documents and pages. A network path to a server is identified by a so-called Uniform Resource Locator or URL having a known syntax for defining a network connection.

The World Wide Web is that collection of servers of the Internet that utilize the Hypertext Transfer Protocol (HTTP). HTTP is a known application protocol that provides users access to files (which can be in different formats such as text, graphics, images, sound, video, etc.) using a standard page description language known as Hypertext Markup Language (HTML). HTML provides basic document formatting and allows the developer to specify links to other servers and files. Use of an HTML-compliant client browser involves specification of a link via the URL. Upon such specification, the client computer makes a transmission control protocol/Internet protocol (TCP/IP) request to the server identified in the link and receives a web page (namely, a document formatted according to HTML) in return.

Turning now to FIG. 33, a block diagram of a representative personal computer system which may be used as a client or server for carrying out the present invention is shown. The personal computer system is a conventional system which includes a personal computer 10 having a microprocessor 12 (viz., an Intel Pentium III), including a central processing unit (CPU), a sequencer, and an arithmetic logic unit (ALU), connected by buses to an area of main memory for executing program code under the direction of the microprocessor 12, main memory including read only memory (ROM) 14 and random access memory (RAM) 16, the personal computer 10 also having disk storage 18, and preferably an internal modem 20 or other means for connecting to a network, such as Ethernet, ISDN, DSL, or other devices for connecting to a network 22, such as the Internet. The personal computer system also comprises peripheral devices, such as a display monitor 24, a printer 26, and one or more data input devices 28 such as a keyboard or mouse. It will be understood that the term disk storage 18 refers to a device or means for storing and retrieving data or program code on any computer readable medium, and includes a hard disk drive, a floppy drive or floppy disk, a compact disk drive or compact disk, a digital video disk (DVD) drive or DVD disk, a ZIP drive or ZIP disk, magnetic tape and any other magnetic medium, punch cards, paper tape, memory chips, or any other medium from which a computer can read. The personal computer 10 may access one or more databases 30 through the network 22, which may be an intranet or the Internet. It will be understood that the illustration of a personal computer system is not intended by way of limitation, and the server may be run on a mainframe computer, microcomputer, or a LAN or WAN of a plurality of personal computers.

The operating system of the computer may be DOS, WINDOWS 3.x, WINDOWS '95, WINDOWS '98, OS/2, AIX, or other known and available operating systems. The RAM also supports a number of Internet access tools including, for example, an HTTP-compliant web browser. Known browser software includes Netscape, Netscape Navigator, Internet Explorer, and the like. The present invention is designed to operate within any of these known or developing web browsers. The RAM may also support other Internet services including simple mail transfer protocol or e-mail, file transfer protocol, network news transfer protocol or “Usenet”, and remote terminal access.

During the first stage a buyer has an option to purchase a certain product at a reduced/adjusted price, with the buyer being either a business or an individual. The product may be goods or services, or it may be an amount of money or line of credit the buyer desires to borrow or purchase from a financial institution. The buyer selects the discount for the original product/service, with the upper and lower limits set by the OPS/TS dual system. The discount limits, as defined by the TS, partially depend on the original product/service category, availability, time of execution and credit agreement between the merchant and the TS owner. The TS owner would be the company providing TS services to the third party merchants. After the buyer selects the $discount, he/she is presented with a list of commodity categories, generated by the TS and presented to the buyer by OPS.

The buyer then must choose at least one or more of the commodities to purchase over a period of time (i.e. maturity period). The customer agrees to purchase the commodity from any of the providers presented for a particular commodity category. Later, commodity providers, from the list presented to the buyer during the commodity selection process earlier, will bid on the bundle of contract options, including this buyer's contract. Both the time period and the total value of the commodities purchased by the buyer may vary, and are determined by the price reduction/adjustment on the original item selected by the buyer.

The buyer may adjust the time period which the trading system defaults to, with the subsequent adjustment to the value of the commodity commitment. The time period is the time over which the buyer must finish paying for the commodity commitment. Prices of the commodities the buyer committed to purchase are not fixed. This means that the original buyer commits to purchase commodities at the regular prices that the commodities will cost in the future. Prices of the committed items/services will vary. They can increase or decrease with time. The only commitment the buyer makes is to purchase selected commodities (items or services) worth committed monetary amount with no fixed prices.

Original merchants who can use the trading system are divided into four main sub-categories including (1) retail merchants; (2) portal merchant sites, e-malls, and product aggregators; (3) service aggregators, auctions, and reverse auctions; and (4) financial institutions. Retail merchants can be any brick and mortar or online company (Amazon, Hechts, Wal-Mart, Office Depot, Dell, etc.). Portal merchant sites (Netcenter, Microsoft Network, America On-line, etc.), e-malls (imall, Vstore.com, etc.), and product aggregators, can act as a singular merchant with respect to OPS/TS. Then any business within the mall, aggregator, or portal can utilize features of the trading system. Thus, TS becomes a universal trading method for all merchants participating in the mall/portal. Service aggregators, auctions, and reverse auctions include online home improvement aggregators (Imandi, Response.com, etc.), auction sites (e-Bay, etc.) and reverse auction sites. TS would act as a universal system for these sites. After the buyer commits to purchase from a merchant, the merchant will be automatically excluded from the list of commodity providers by the TS for this particular transaction.

Commodity categories, as defined by the trading system, can be subdivided into six main categories including (1) retail commodities, (2) common spot commodities, (3) service commodities, (4) auction sites, (5) indirect commodity providers, and (6) outsourcing services.

Retailers can include both brick and mortar stores, online stores, and hybrids of the two. For retail commodities, a buyer would agree to purchase a certain value of any number of goods or services that the retailer offers. The buyer does not select a particular set of goods at the time of commitment, just the monetary value of products to purchase from the retailer over a period of time. Some examples are supermarkets (Giant, Food Lion, Safeway, Publix, etc.), home improvement chains (Home Depot, Lewis, etc.), department stores (Federated Department Store, etc.), electronics/computer superstores (Best Buy, CompUSA, etc.), office supply stores (Office Depot, Staples, etc.), superstores (Wal-Mart, Target, etc.), club warehouses (Costco, BJ's, Sam's, etc.), etc. Examples of online retailers, which include pure online merchants or click and mortar merchants, include direct sales manufacturers or original equipment manufacturers (Dell, IBM, Cisco, Compaq, Microsoft, etc.), online merchants (Amazon, Buy.com, Ashford.com, etc.), and click/mortar merchants (Office Depot, Wal-Mart, etc.).

Common spot commodities include commodities purchased over a period of time, such as gasoline, plastics, steel, electricity, water, chemicals, etc. Service commodities include independent service providers (America Online, @Home, Earthlink, MSN, etc.), phone services (Bell Atlantic, MCI WorldCom, AT&T, Excel, etc.) maintenance services (car repair, etc.), direct satellite broadcasting services (Direct TV, DISH Network, etc.), etc. Service commodities also include leasing contracts (car leases, equipment leases, etc.), financial services, (loan agreements, etc.), insurance services (health insurance, home insurance, life insurance, etc.), etc. Auction sites, such as e-Bay, etc., are considered a commodity category when a buyer agrees to purchase a certain value of any number of products or services that are selected at a particular auction site. Indirect commodity providers are considered a commodity category when a buyer agrees to purchase a certain value of any number of commodities provided by a third party market exchange (metal marketplace, chemical market site, etc.). Outsourcing services, such as computer related outsourcing services, including integrators and system maintenance (CSC, EDS, Anderson Consulting, IBM), and application service providers, are considered a commodity category.

The second stage of the process involves aftermarket trading of the bundles of original buyers' contract options generated at the first stage. When the original buyer commits upon the original transaction, each commodity option committed to purchase by the buyer is immediately converted into a computer software object-packaged contract named SIMPLET (simple encapsulated trade object). The SIMPLET object includes buyer's data, electronically encrypted with private encryption key, which will be available to the commodity provider upon the completion of the bid. There is no public interface or handle available to the bidders before bidding.

The contract options will be traded separately as a bundle of SIMPLETs, hereinafter referred to as a COMPLET (combined multiple SIMPLETs). A COMPLET is created by combining SIMPLETs based on a buyer's geographical location, commodity category, maturity period, or other additional parameters. The original product-commodity category relationship is cross-industry formed, and is not necessarily based on a single industry market. The displayed list of commodity categories offered to the buyer does not indispensably depend on the category of the original purchased item or service.

The trading system bundles SIMPLETs and COMPLETs over a fixed period of time. After a COMPLET is finalized by the trading system, it is auctioned to a variety of commodity providers, which provide commodities that match the COMPLET's commodity category. Commodity providers must register prior to trading with the trading system owner. The COMPLET is designed in such a way that only limited data members are public, i.e., available for a view by the commodity providers remotely over the Internet or a private network.

Every COMPLET's public interface contains the following data: (1) commodity category, geographical location averaged out, i.e., north atlantic states or north Virginia; (2) COMPLET's ID; (3) the value of the contracts that constitute the COMPLET; (4) the initial minimum bidding price; (5) the number of contracts (i.e. SIMPLETs) in the COMPLET; the average COMPLET's risk; (6) the average individual contracts risk: and, (7) the average time period of contracts. At the time of a COMPLET's forming the trading system calculates all averaged variable values and assigns these values to the COMPLET's public interface data members.

Various commodity providers have an option to electronically monitor COMPLETs available through the Internet, proprietary networks, or other electronic means, and have an option to automatically or manually bid for a particular COMPLET or multiple COMPLETs. The initial minimal bidding price starts at the value equal to the sum of all original buyers' chosen product discounts adjusted according to the average COMPLET's risk plus the trading system's owner minimal fees. The winner of the bid receives the full data on the COMPLET package including buyers' credit information, address, and other related data. The bid winner then electronically transfers funds equal to the winning bid to the trading system originator. The bid winner then notifies in e-mail or by any other means the original buyers (which contracts constitute the COMPLET) of the method of payments and arrange the schedule of purchases, if applied, with the buyers. The trading system then sends funds to the original merchant in the amount of the original discount selected by the buyer minus the handling fees charged by the trading system.

There are two major implementations of the trading system. One implementation is when the trading system is Internet or other distributed computer network based, including a Virtual Private Network. In this case the product selection will be presented online (via World Wide Web) or through a wireless communication. The commodity contract option trading system will be Internet based as well, with business-to-business transactions having an option to conduct trading through a separate electronic system.

The other implementation is when the trading system is implemented via a set of kiosks installed at brick and mortar retailer locations. In this case, after a customer selects an original item to purchase, either the customer or a sales representative selects the item from the kiosk's interface. Then he/she selects the discount and commodities to purchase over time. The kiosk is then connected to the retailer's central application server set (can be regional) via the Internet, a private network, ar a Virtual Private Network (through land lines or wireless connection). The pertinent information/data for the purchase, sent by the kiosk, is then processed at the central server. From there on the merchant acts as an original merchant described above. A different kiosk implementation includes a kiosk connected remotely (through landlines or wirelessly) to the trading system owner's server through the Internet, a private network, or a Virtual Private Network. The trading system owner would then send the necessary information back to the original merchant and kiosk. All transactions are completed through a secure, encrypted system (at least 128 bit encrypted via public key algorithm) offering full security and privacy to all involved parties. An agreement between a commodity provider and the trading system originator should be made before any transaction takes place in the interest of security of both parties.

The following is an example of the trading system for a direct sales manufacturer. An original buyer, located in the greater Washington area, connects to the DELL computers web site to shop for a new notebook computer. He/she decides to spend $1,800 on the notebook computer. However, he discovers that he/she really likes a new notebook computer that costs $2,600. Since the buyer does not want to exceed his/her predetermined spending limit he decides to use the trading system method. The buyer selects an $800 discount. To cover this discount, the buyer commits to purchase $3,500 worth of groceries at the local food supermarket. The direct sales manufacturer then sends the buyer's credit data to the trading system. The buyer's contract is bundled with other buyers from the same greater Washington area into one COMPLET. The trading system puts the COMPLET out for bidding on the trading system owner's auction site. Presume that the Foodlion supermarket chain wins the bid for this contract among other contracts in the COMPLET bundle. The original buyer is then informed by e-mail that he must purchase groceries at the Foodlion supermarket (that is 5 minutes driving away from the buyer's house) worth $3,500 during the next year. Additional information and the method of payment are also included in the e-mail. The commodity provider may recommend to the original buyer to use the supermarket's advantage credit card to make the purchase.

The following is an example of the trading system for a lease. A small construction company would like to lease for one year two earth moving machines made by Caterpillar. The average lease price is $10,000 a year for a total of $20,000. The small construction company would like to avoid the increase of its short-term debt and therefore selects the trading system services. A company's officer selects a $4,000 discount of the $20,000 price. To cover this discount the officer chooses to purchase $12,000 worth of gasoline for his company over the next three years, purchase car fleet repairs at a repair chain, and to lease a small car for the next two years for his company. The total commitment is worth $18,00 that his company would spend anyway. Thus, by limiting its procurement choices the company will save $4,000 on the lease. The trading system will bind these purchase contracts into three COMPLETs together with the other buyers' purchase contract options, which will be auctioned at the trading service's site. The company will receive payment notification and other information from the bid winner during the next three days.

The following is an example of the trading system for a gift registry kiosk. A young groom would like to purchase an engagement ring for his bride. The price of the diamond ring he selects is $4,500 that significantly exceeds the price of $2,700 he decided to spend on the ring. The groom does not want to take on additional credit card debt. However, a sales person offers him a way to finance his dream. They login to the trading system kiosk interface. They select the expensive ring and look at the list of commodity categories the groom can select from and commit to purchase over the next two years on the kiosk interface. The groom agrees to consider purchasing goods/services from the companies listed for each category. After careful consideration, the groom agrees to commit to purchase $2,800 worth of electricity and gas over the next eighteen months, $2,500 worth of phone services over the next two years, and $1,200 worth of satellite television broadcasting over the next two years to compensate for an $1,800 discount on the selected ring. The trading system binds these purchase contracts into three separate COMPLETs together with other buyers' purchase contract options that will be auctioned at the trading system site. The original buyers will receive notification from the bid winners during the next three days. In the notification there will be information on the commodity providers and the ways of payment.

The following is an example of the trading system for an online gift registry. An original buyer purchases a DVD player on line. The buyer selects a discount of $150 for a retail price of $349.99. The buyer then commits to make $900 worth of purchases at the local supermarket (Giant) during the next eighteen months. The buyer also commits to buy $650 worth of electricity from the new utility distributor in the market (Southern Inc.). The trading system will bind these purchase contracts into two COMPLETs together with other buyers' purchase contract options, which will be auctioned at the trading system's site. The original buyer will receive notification via e-mail from the bids winners during the next three days. The method of payment preferable to the commodity provider will be discussed in the e-mail.

The following is an example of the trading system for home improvement services. An original buyer is looking for an interior paining and repair job. To select a contractor the buyer logs in to a reverse auction home improvement site (such as Imandi). After accepting a winning bid of $7,230 from a local contractor, the buyer uses the trading system and selects a $2,650 discount. To enable the discount, the buyer commits to purchase $3,500 worth of lumber and other materials from any home improvement store in the list. The buyer also commits to purchase $2,300 worth of office supplies for his/her home business, and commits to purchase $8,200 worth of goods from local supermarkets on the supermarkets list. The trading system will bind these purchase contracts into three COMPLETs together with other buyers' purchase contract options, which will be auctioned at the trading system's site. The original buyer will receive notification via e-mail from the bids winners during the next three days. The method of payment preferable to the commodity provider will be discussed in the e-mail.

The following is an example of the trading system for a kiosk. An original buyer decides to make purchases at a home improvement superstore, such as Home Depot. The buyer purchases $500 worth of lumber from the home improvement superstore. The superstore's salesperson recommends to the buyer to use the trading system method implemented at the trading system kiosk. The buyer, with the salesperson's help, interacts with the trading system kiosk interface, selects items to purchase, and makes prices adjustments worth $140. To compensate for that discount the buyer elects to purchase $790 worth of food from the local food superstore (any displayed on the buyer list). The trading system will bind these purchase contracts into one COMPLET together with other buyers' purchase contract options, which will be auctioned at the trading system site. The original buyer will receive notification via e-mail from the bid winner during the next three days. The method of payment will be discussed in the e-mail.

The following is an example of the trading system for a medium-sized company. A medium-sized company purchases seven computer workstations and two printers from a direct manufacturer (Gateway) for $18,550. The company's buyer selects a discount worth $3,420 and commits to purchase office supplies worth $4,250 over a one year period, and also selects to utilize the services of a professional computer services consultant worth $8,420 to resolve their inventory and e-mail software installation problems. The trading system will bind these purchase contracts into two COMPLETs together with other buyers' purchase contract options, which will be auctioned at the trading system site. The company will receive notification from the bid winner during the next three days.

The following is an example of the trading system for wireless access. A buyer in London using a wireless cell phone/Palm organizer connects to the Amazon.com.uk web site to purchase a DVD player and twelve DVD disks on line. This purchase is worth 470 pounds. The buyer uses the trading system and selects 150 pounds of discount. To cover the discount the buyer commits to purchase an Internet connection contract with an individual service provider worth 640 pounds. The trading system will bind these purchase contracts into one COMPLET together with other buyers' purchase contract options, which will be auctioned at the trading system site. The company will receive notification from the bid winners during the next three days. The notification will include a method of payment description.

The following is an example of the trading system for a kiosk in an electronics store. An original buyer in London purchases a DVD player and twelve disks that the buyer considers expensive. The buyer selects 200 pounds of discount using the trading system interface. To compensate for the discount the buyer commits to purchase 1600 pounds worth of products from any of the local supermarkets on the list. The trading system will bind this purchase contract into one COMPLET together with other buyers' purchase contract options, which will be auctioned at the trading system site. The buyer will receive notification from the bid winners during the next three days. The notification will include among other items information on a method of payment preferable to the electronics store.

The trading system can be embedded into particular portal store services in such a way that all portal stores have a universal access to the trading system. Thus, each merchant that belongs to a portal will have the trading system available for transactions by the merchant.

The following is an example of the trading system for a farmer. An original buyer would like to purchase a new agricultural automated harvester. The buyer selects a discount of $12,000 on a $125,000 purchase. The buyer selects mill and storage services for grain over the next three years worth $35,000, gasoline purchases worth $6,900 over the next two years, agrochemical purchases worth $24,000 over the next two years, and cell phone services worth $2,400 over the next 28 months. The trading system will bind these purchase contracts into four COMPLETs together with other buyers' purchase contract options, which will be auctioned at the trading system site. The farmer will receive notification from the bid winners during the next three days.

The following is an example of the trading system for links to commodities exchanges. A company decides to purchase a new molding machine for the credit card printing and molding business. The machine costs $77,000. The company has a limited credit line and does not want the exposure to additional risk running high credit interest payments. The company executive connects with an Internet market place that trades in these machines. The web site implements the trading system. To decrease the price of the machine, the company's executive decides to select $22,000 discount using the trading system. The company executive selects an option to commit to purchase a number of copper ingots worth $190,000 over the next two years. The trading system displays this contract bundled with others on the Internet metal market exchange (like esteel.com and others) and after selling it to the winner, sends all necessary information to the bid winner. The bids winner sends confirmation to the company's executive within the next three days. This will include information on the method of payment preferable to the commodity provider.

It will be understood that the original merchant may be a bank or financial institution and the original transaction may involve the advance of money or financial credit to or on behalf of the buyer. For example, buyer X may seek a loan of $15,000.00 from bank ABC. Bank ABC will lend the money, but requires an interest rate of 12%. An interest rate of 12% on a principal of $15,000.00 is unacceptable to buyer, but the buyer would be willing to pay 12% on a principal of $12,000.00. Buyer therefore uses the electronic contract make and broker according to the present invention, requesting a discount of the $3,000.00 difference from the system in exchange for the contractual commitment to purchase goods or services under a long term contract. Similarly, company Y may seek a letter of credit in the amount of $25,000.00 from bank ABC. However, company Y only has sufficient liquid assets to pay for a $20,000.00 line of credit. Company Y may then resort to the system of the present invention to obtain the additional $5,000.00 through long term contractual commitments, e.g., for the lease of company vehicles, purchase of machinery or office supplies, etc.

It will also be understood that the Commodity Providers may be individual companies, or a syndicate or consortium of various companies.

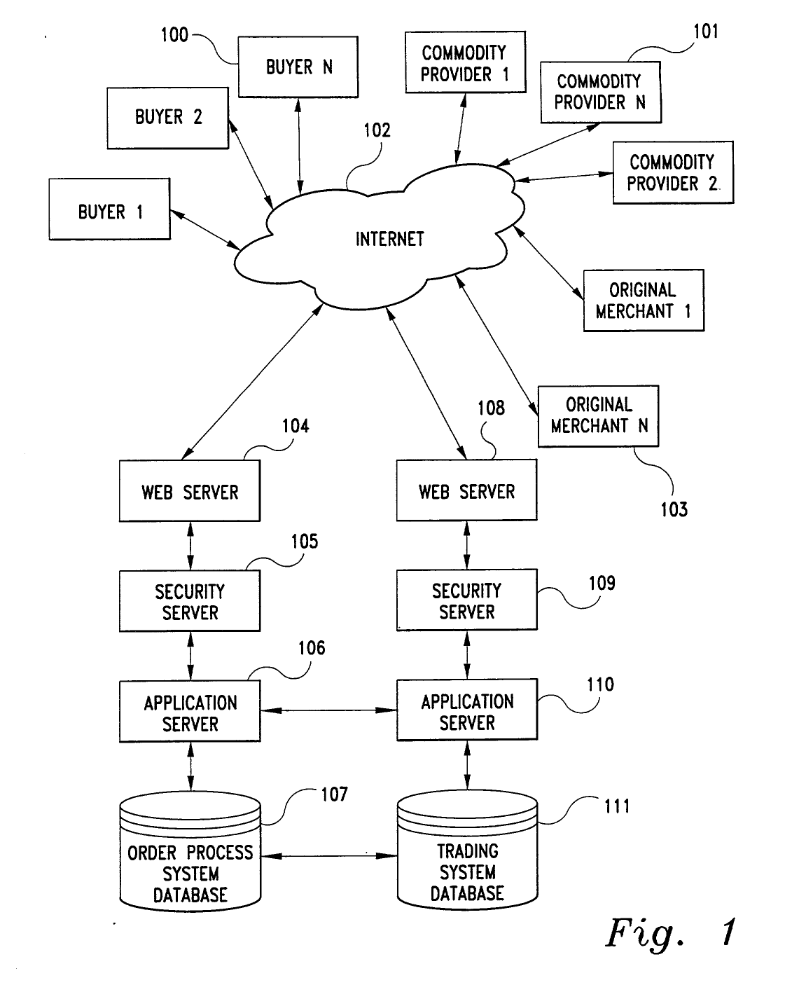

FIG. 1 illustrates the overall computer architecture of the proposed system. It is implemented as a dual order processing system and trading system (OPS/TS). FIG. 1 shows buyers 100 interacting with original merchants 101, 103 over the Internet 102 (including Virtual Private Networks). The OPS includes web servers 104, security and application servers 105, 106, and an OPS database 107. The servers functionality can be implemented in one application server. The TS contains web servers 108, security servers 109, application servers 110, and a TS database 111. The OPS application server 106 communicates and synchronizes data sets with the TS application server 110.

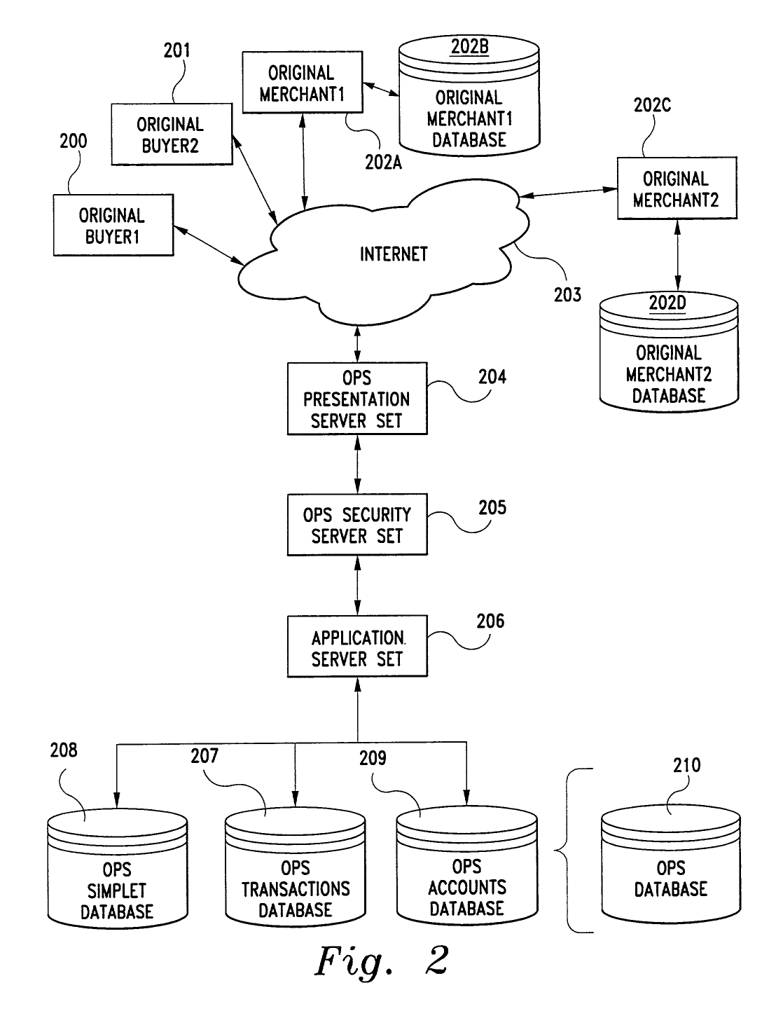

FIG. 2 illustrates the architectural overview of the order processing system (OPS). It includes a presentation of the OPS database 210. The OPS database 210 includes an OPS account database 209, an OPS transactions database 207, and an OPS SIMPLET database 208. OPS interacts online with original merchants 202A, 202C. Original buyers make purchases over the Internet or wireless interacting with original merchants. The OPS system includes OPS web servers 204, OPS security servers 205, and OPS application servers 206.

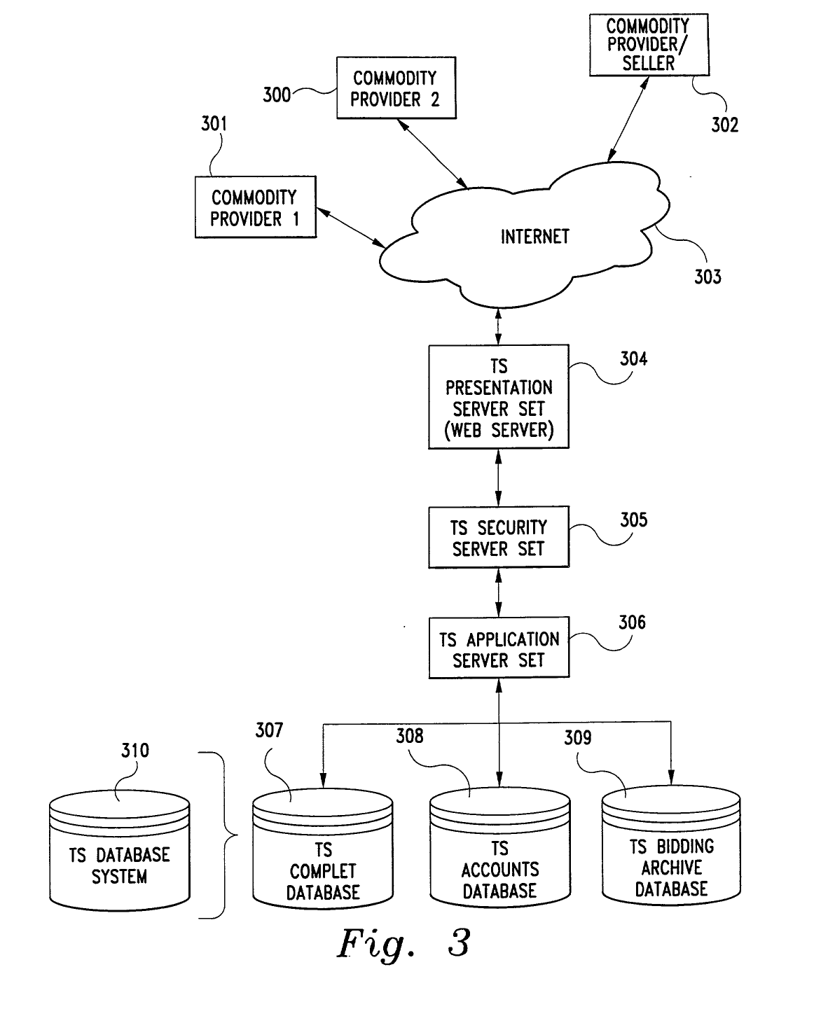

FIG. 3 illustrates an architectural overview of the trading system (TS). The TS includes details of the TS database 310. The TS database system includes a TS COMPLET database 307, a TS accounts database 308, and a TS bidding archive database 309. The TS interacts online 303 with commodity bidders (commodity buyers and sellers) 300, 301, 302. The TS also includes TS web servers 304, TS security servers 305, and TS application servers 306.

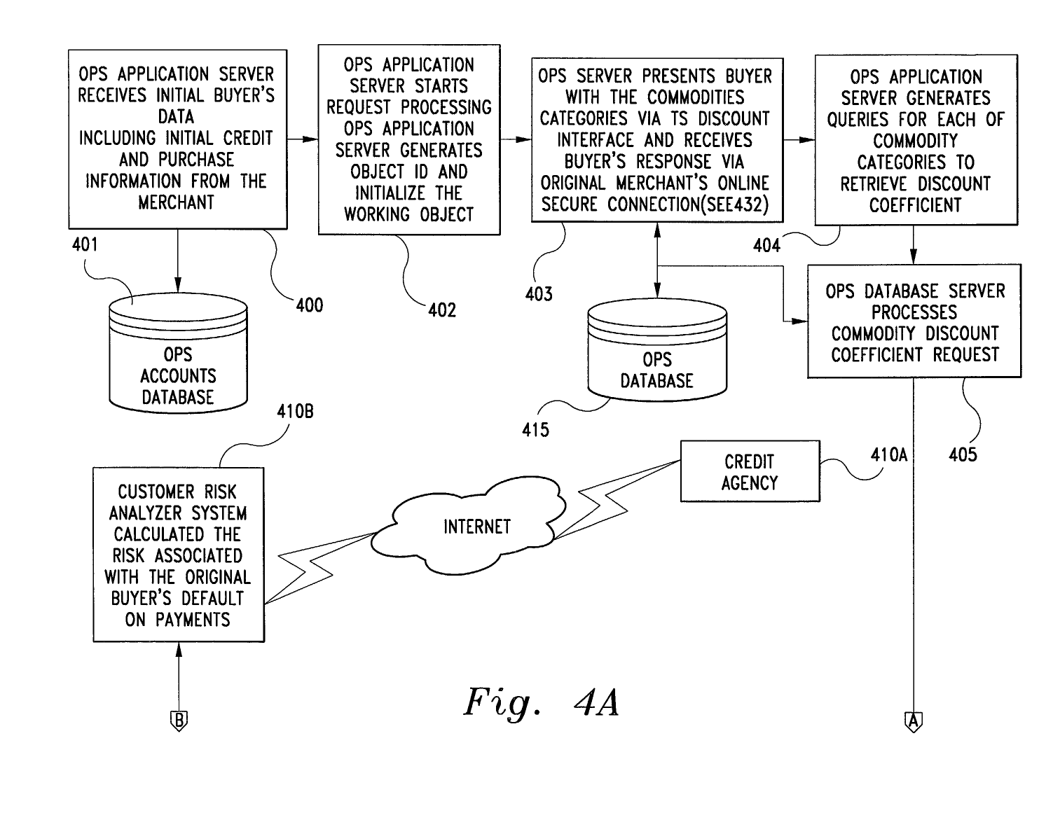

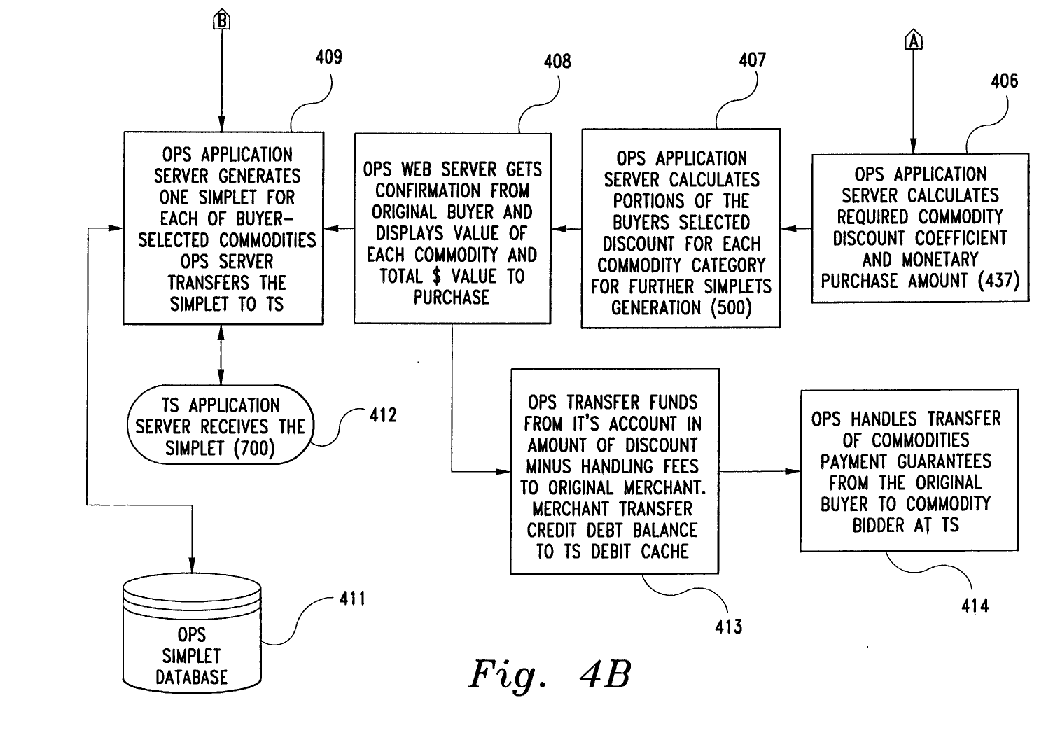

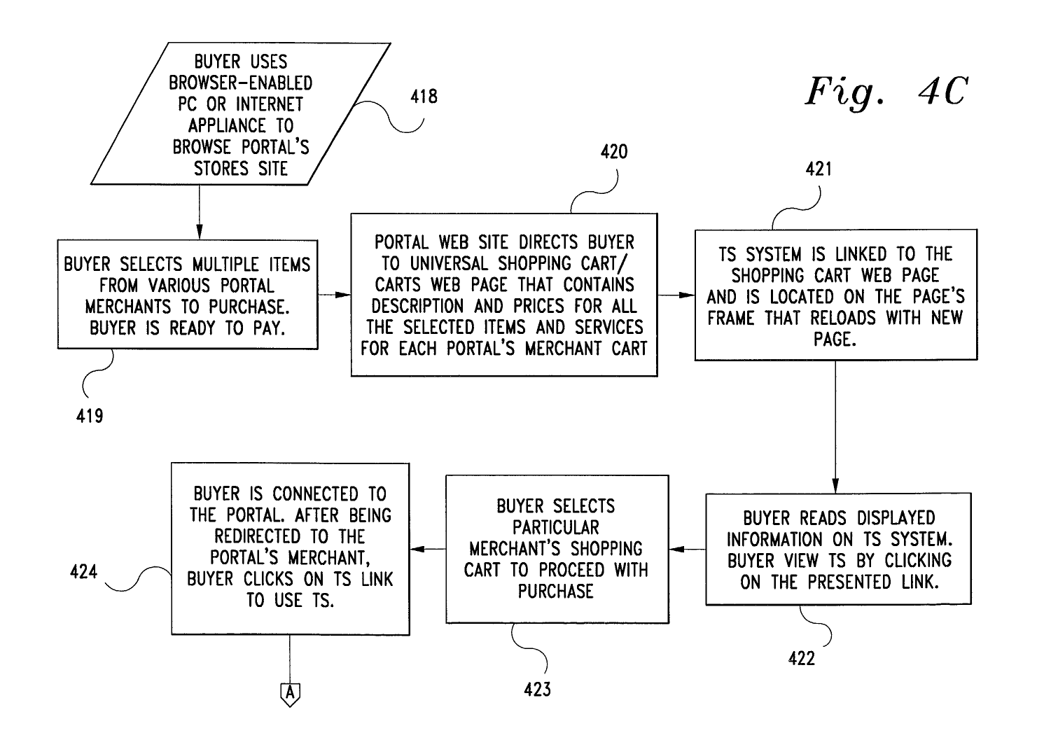

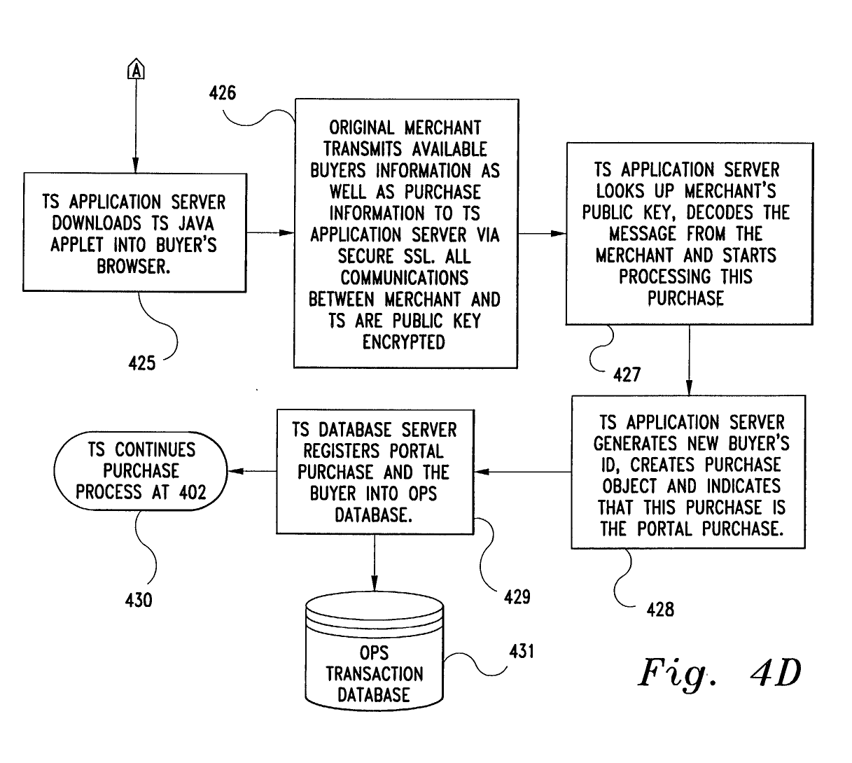

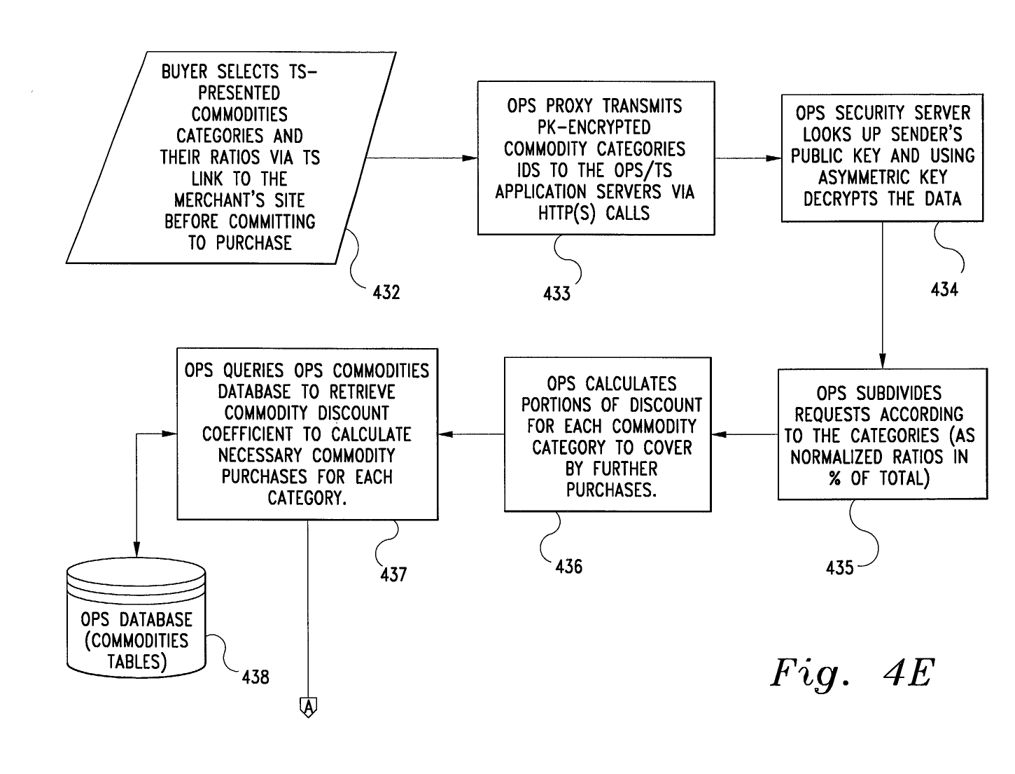

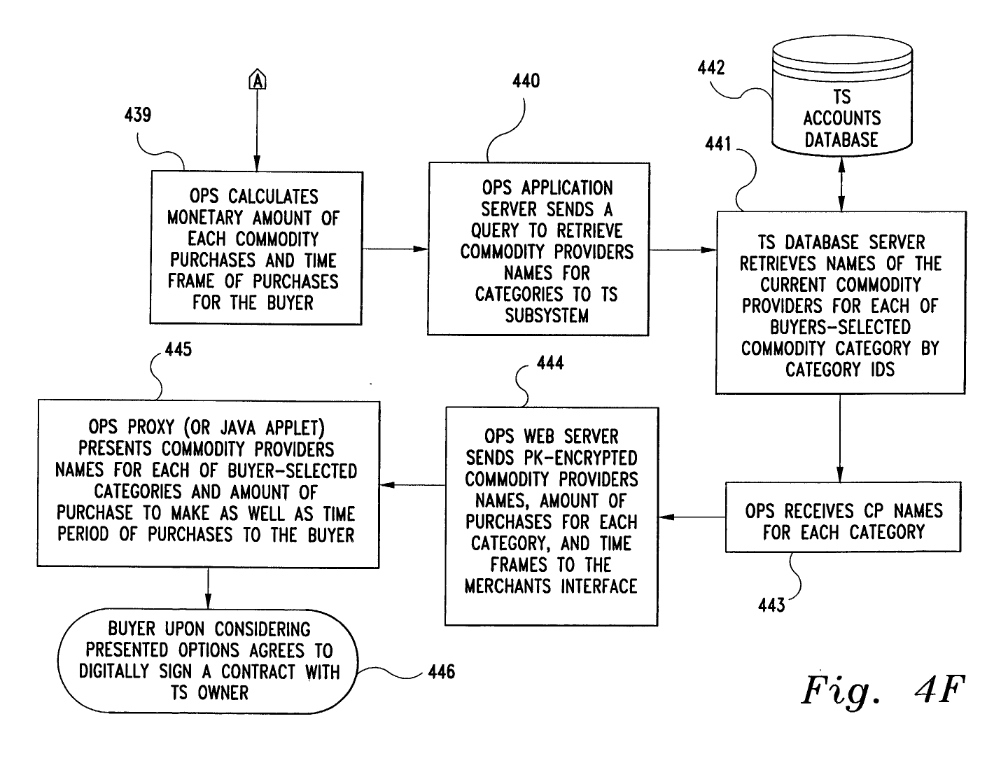

FIGS. 4A-4B and 4E-4F illustrate the mechanism of discount selection by the buyer, the TS owner's link to the original merchant web site, and interaction with the merchant, and the display of the TS discount interface for the buyer's selection. The system includes back-end processing of the presentation of the commodity categories, indirect interaction with the buyer who selects commodity categories and their ratios in the purchase. It also shows the details of the bundling of the discount with the commodities purchases, calculation of the monetary amounts of the commodity categories to purchase proportional to the buyer selected ratio and commodity discount coefficients. It also details the encrypted SIMPLETs (a.k.a. simple trade object implemented as a software object) generation from the data provided by the buyer and the merchant, as well as an individual buyer's risk calculation based on the credit reports from the third party. After the buyer logs in onto a merchant's web site or portal or uses retail kiosk in a brick and mortar store, the buyer selects particular items or services to purchase from the merchant. The order processing system (OPS) as part of the dual OPS/TS system is linked to the merchant's site (most often on the frame) or has a proxy program implemented in retail kiosk (PC or Internet Appliance). When the buyer is ready to use the TS the buyer can click on or select by other means a TS link to a merchant's site. Upon the event of clicking or other similar events, the merchant's server will send all available information on the buyer at the time to the TS site. The merchant's server software will send XML-described merchant and buyer's data over HTTP and HTTP(S) calls to the TS server. Further data synchronization between the merchant and the TS owner's database is performed by the same mechanism. The buyer's and the merchant's information includes the session ID, purchase information including items/services description and initial price of those, and the merchant's ID.

If the buyer already purchases some items/services at the merchant's site, the buyer's credit information is available to the merchant before the actual purchase. It is especially reasonable for business transactions, when the buyer before purchasing items or services (for example from a direct sales manufacturer) already established a purchasing account with the original merchant. The OPS application running on the OPS application server receives the data 400 and records the original transaction into the OPS Accounts database 401 using the original merchant's ID as a primary key.

The buyer's and purchase data are public key encrypted and transmitted (message) to the OPS web server 204 directly. The OPS security server 205, using public and private keys, decrypts the sent data and transmits the message to the application server 206. Since in some cases the buyer's name and some other data are not known initially, the OPS application generates, initially, a working software object at step 402 with a transaction identification, a session identification, a time stamp, an original merchant identification object's data members initialized. In such cases when a buyer's name, and other personal data such as points of contact, address and credit data are known, the OPS application will create a buyer software object and initialize available private data members and will store them in the OPS accounts database under the buyer's ID/name. At step 403, OPS will display cross-industry commodity category names retrieved from the OPS database to the buyer at the merchant's site. OPS is connected via a database link to the TS database. OPS stores valid commodity category names, and a list of current commodity providers who registered with the TS accounts database previously and were active recently (as reflected in the TS bidding archive database) in OPS database 415. The buyer is then allowed to select multiple commodity categories he/she wants to purchase over a predetermined period of time.

After a buyer selects the commodity categories and agrees to purchase commodities from the list of providers, the OPS application server receives commodity purchase information as well as commodity categories purchase amount ratios selected by the buyer. The OPS application software subdivides received categories amount purchases to be done according to the normalized categories ratios. Also, OPS calculates the amount of discount to cover for each category, since a buyer-selected discount has to be covered by the buyer's purchases of multiple commodities in more than one category at a time. However, to cover n % of a discount by purchases of commodity category j, OPS takes into account a discount coefficient for the particular category. This discount coefficient is tabulated in the TS COMPLET database and is constructed based on the wholesale profit margins in category j, the averaged amount of purchases done in the category, i.e. history of purchase. OPS application requests 404 and retrieves 405 commodity discount coefficients from the OPS database 415. The OPS application server 206 calculates the required commodity discount coefficient and monetary purchase amount 406 and calculates the portions of the buyer's selected discount for each commodity category 407.

In more detail, as shown in FIGS. 4E-4F, the buyer selects the commodity categories and the percentage of the discount to be funded by each category via a link from the merchant's site to the trading system 432. The OPS transmits the commodity categories to the OPS application servers 433, and the OPS security server decrypts the data 434. OPS subdivides the requests according to the categories (as normalized percentage ratios of the total) 435, and calculates the portions of the discount for each commodity category to cover by further purchases 436. OPS queries 437 the OPS commodities database 438 to retrieve the commodity discount coefficient to calculate the necessary commodity purchases for each category.

OPS calculates the monetary amount of each commodity purchase and the time frame of the purchases 439. The OPS application server 206 sends a query to retrieve the names of commodity providers for each category 440, retrieves the names 441 from the TS accounts database 442, and OPS receives the commodity provider names 443. OPS then sends the commodity provider names, purchase amounts, and time frames for display on the merchant's interface 444, where the information is displayed to the buyer 445. The buyer may then digitally sign a contract with the TS owner to purchase the commodities in the categories selected in the amounts and for the time frames displayed 446 in exchange for the discount, which, referring back to FIG. 4B, is then transferred to the original merchant 413. When the buyer digitally signs the contract at 446, the buyer also agrees to authorize the trading system (TS) to charge his credit card (or line of credit) for the amount of the discount as a guarantee for carrying out the time purchases. The TS transfers the guarantees to the successful commodity provider bidders (as described below) after the auction.

In calculating the discount allocable to each commodity category, the monetary amount of a portion of the buyer-selected discount on the original purchase is:

$discountⱼ=$discount*(Ratio % of Catⱼ) (1)

where Ratio % is a buyer-selected portion of the total purchase amount for the commodity category j, normalized to 100%, $discountⱼ is for SMPᵢ of Catⱼ. (where SMPᵢ is a series i of SIMPLETs in commodity category j) and $discount is the total amount of the buyer-selected discount. The amount of commodity category j to purchase to cover $discount is:

$contractᵢCatⱼ=$discount*(Ratio % of Catⱼ)*RateᵢCatⱼ (2).

However, buyers compliance with the future purchase contract is also dependent on the previous buyer's credit history and other factors.

Referring back to FIG. 4A, the OPS Customer Risk Analyzer calculates the risk associated with the original buyer at 410B, and retrieves the buyer's credit history report from a third party credit agency 410A over the Internet. The buyer is presented with selected commodity categories' purchase amounts and time periods over which the purchases must be made by the buyer. The buyer digitally signs the contract between the TS Owner and the buyer, and agrees that the TS Owner is the buyer's proxy for the second credit balance transfer to the commodity provider at step 408. The OPS application server generates encapsulated object (a.k.a. SIMPLET) for each commodity category purchase for the buyer 409. SIMPLET is implemented as a software object, encapsulating data members such as software-generated SIMPLET ID, Buyer ID, Transaction ID, Buyer Name, Address, point of contact, credit risk, Value of Commodity Category j purchase, timestamp, time period for the purchases, portion of buyer-selected discount, commodity category name and ID, etc. SIMPLET is symmetrically encrypted with a generated private key. OPS will store SIMPLETs records in the OPS Simplet Database 411 identified by the combination of SimpletID and BuyerID. Finally, OPS transmits SIMPLET to the TS subsystem of dual OPS/TS. The TS application server will receive the SIMPLET 412.

FIGS. 4C-4D describe Universal Portal TS implementation. UNIVERSAL Dual Trading System implemented for Portals (for example, Yahoo! Portal) and mixed Portals/Department Stores (for example, Amazon.com). The original buyer can browse a portal's store sites 418 and select goods and services from the multiple merchants on a portal 419. After original buyer selected goods/services (from multiple various merchant stores that sell goods/services on the same Portal) into shopping carts, that will be shown on the Portals Shopping Cart Web Page, buyer continues with checkout process 420. A link to the TS Owner's web site will be on the Portal's frame, which reloads each time the buyer changes the site page 421. The buyer can read information of the Trading System 422 and then selects a particular merchant's shopping cart to proceed with a purchase 423.

For example, a buyer selected an electronics store on the Portal. After clicking on the link to the Portal's store, buyer is redirected to the electronics store. This event causes a frame displayed on the buyer's PC or Internet appliance to reload together with the link to the TS owner's site. Buyer then after initiating purchasing, may start using the TS. Buyer clicks on the link to the TS site 424. This event downloads a Java Applet, in the first implementation, into the Internet Browser that buyer's use 425. As shown in FIG. 4D, the original merchant transmits available buyer information as well as purchase information to the TS application server 426, where the TS decodes the encrypted message 427, generates a new buyer's ID, and creates a purchase object indicating that the purchase is a portal purchase 428, registers 429 the portal purchase and the buyer into the OPS transaction database 431, after which the transaction proceeds 430 as set forth at steps 402 et seq., described above.

Accordingly, the buyer selects a discount in the limits defined by TS for the current set of selected items/services in the Portal's store shopping cart. After the discount selection, an original buyer selects commodities categories from a number of Commodity Providers on the list (up to three at a time) displayed for each category. The list of commodities is presented via Java Applet already downloaded.

After the original buyer commits to the Commodities purchase over period of time, the Portal distributes the refund for the discount to the various merchants proportionally to the total cost of the purchased items/services from the individual store, as well as other criteria such as any agreement between TS and the merchant to a deeper discount on the purchased item.

The Original Buyer may digitally sign the contractual obligation with the TS to purchase Commodities over period of time. For this purpose, among others, all the communication of TS with the merchants is encrypted using asymmetric public key algorithm.

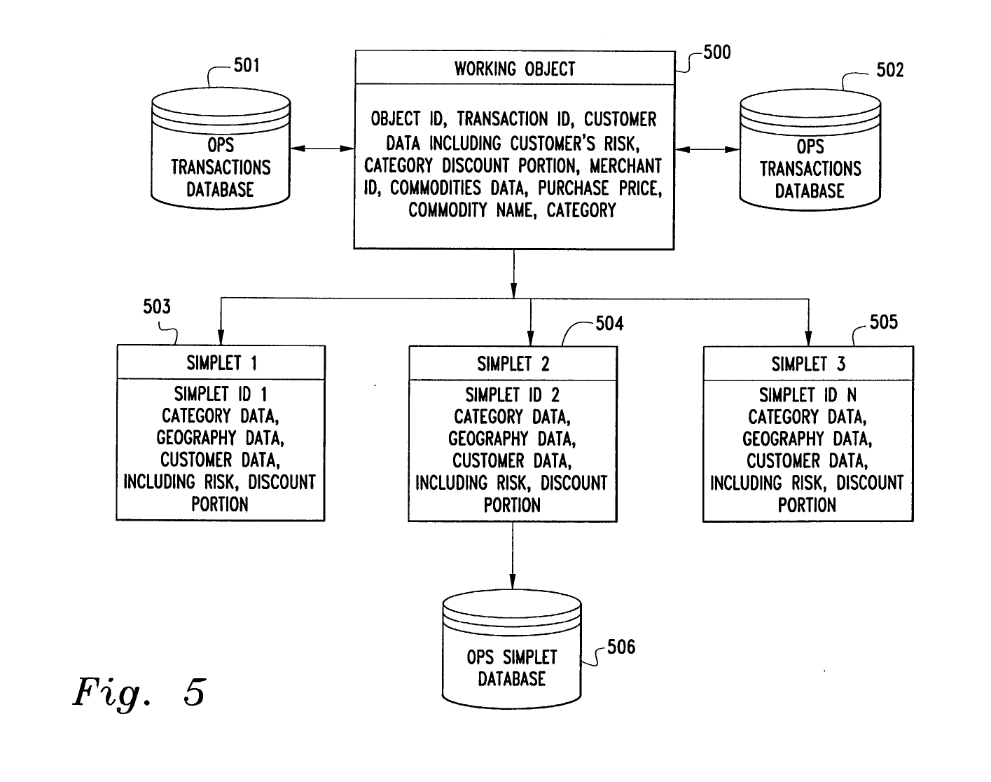

FIG. 5 illustrates SIMPLET (simple trade object implements as a software object) generation by the OPS application server. SIMPLETs are derived from the initial working object 500. The working object 500 contains session ID, Object ID, transaction ID, merchant name and ID, purchased item initial price, discount selected, and multiple commodity category names data members. The SIMPLET data members were initialized with data transmitted by the merchant's server and stored in one or more OPS databases 501, 502. Each working object 500 contains one or more commodities data members, while each SIMPLET has only one commodity category data and associated data members, such as $discount, purchase amount, etc. A single working object 500 may generate a plurality of SIMPLET objects, e.g., SIMPLET 1 503 SIMPLET 2 504, AND SIMPLET 3 505. All generated SIMPLETs are stored in the OPS SIMPLET database 506.

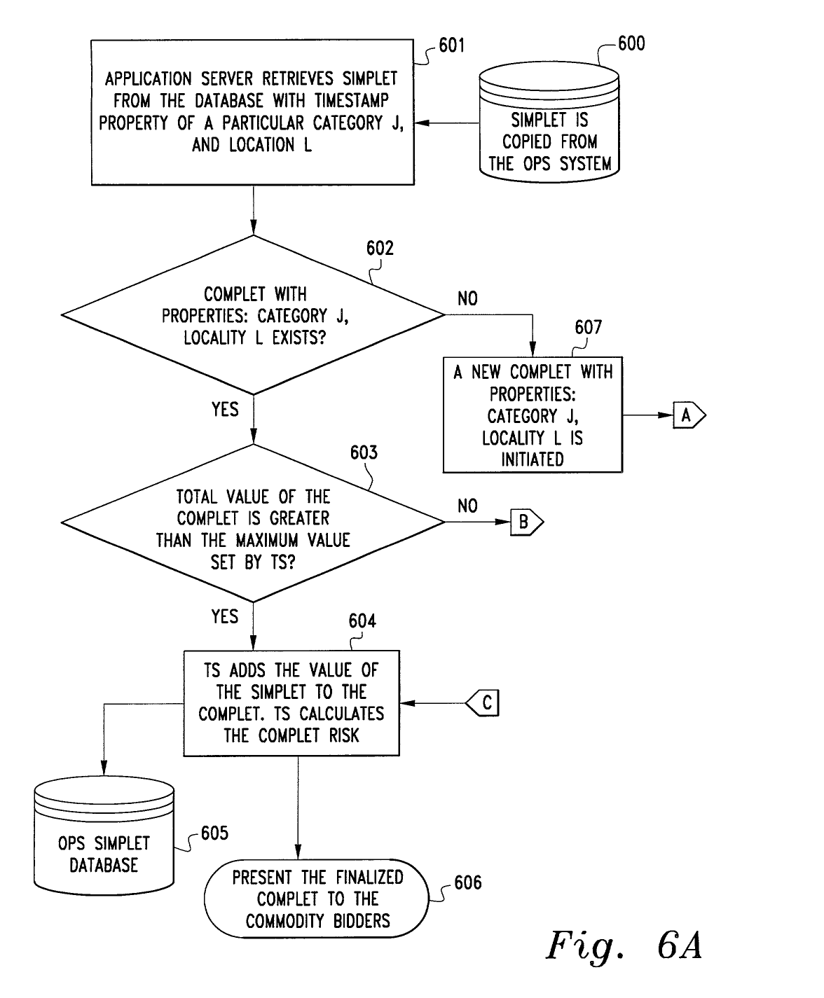

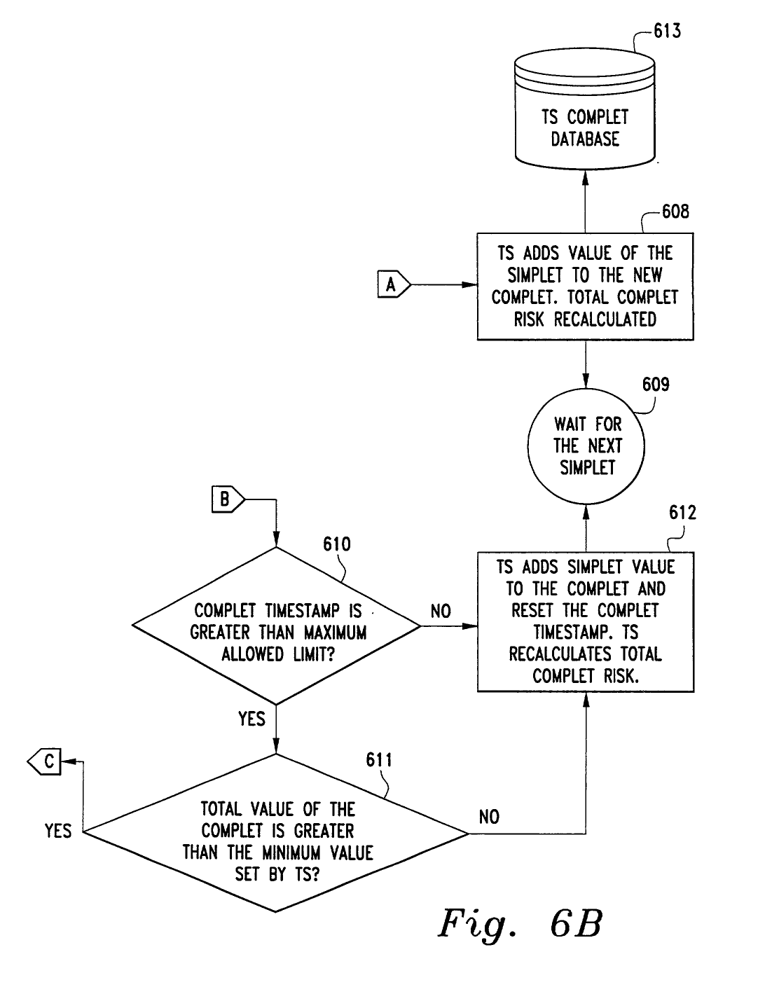

FIGS. 6A-6B illustrate COMPLET (combined multiple SIMPLET objects) generation and accumulation from a plurality of SIMPLET objects by the TS (trading system) application server 306. TS initiates COMPLET generation with each SIMPLET being copied by the TS application from OPS 600. Each new COMPLET object is created by TS by assembling/bundling together a number of appropriately grouped SIMPLET objects (each SIMPLET is created for only one Original Buyer and commodity category as noted above) identified by the same category and location (if applied). Thus, each COMPLET will contain ALL the SIMPLET information as well as unique COMPLET data including a COMPLET object worth (referred to as $COMPLET), a COMPLET ID, a COMPLET Time stamp, an initial minimum bid, estimated average COMPLET Risk data, etc.

As was noted before, each SIMPLET contains all relevant customer data, including Buyer ID, First and Last Name, SIMPLET Timestamp, credit card/credit line information including individual customer's risk of default, address, phone number, email address, other ways of contact, etc. Each SIMPLET also contains Category Name, General Location Information (for example, Northeast) that provides a measure of geographical “granularity”, and a contract worth, i.e. how much of “commodities” the original buyer committed to purchase over a defined time period. The TS application server retrieves 601 the next SIMPLET, e.g., SIMPLETᵢ, from the database 600, together with information regarding the SIMPLETᵢ commodity category j and buyer's location L.

The TS COMPLET generator must decide whether to add SIMPLETᵢ, currently in the process, to the already existing COMPLET or create a new COMPLET 602. TS checks all COMPLET objects of the commodity category j and location L, if applicable, that are not in a bidding process yet 602. Their interfaces are located in server set memory (RAM) . TS starts searching for the available COMPLET objects among the many COMPLET objects in server's memory. After TS finds the first available COMPLET of the selected category/location, the System calculates the total value of the $COMPLET +$SIMPLETᵢ. If the sum exceeds Maximum Value set by the TS 603, TS adds the values 604, stores them in the COMPLET database 605 and presents the finalized COMPLET to the bidding commodity providers 606 via web site visual presentation (manual) or pipe the information to the bidders software agent (automated bidding).

If the total value of the COMPLET, i.e. $COMPLET, does not exceed the maximum allowed 603, TS compares the COMPLET timestamp to a maximum allowed time limit 610. If the time limit is exceeded, TS compares $COMPLET to the minimum value set by Statistical Complet Analyzer 611. If the minimum is exceeded, TS stores COMPLET in the database 605 and releases the finalized COMPLET to the bidders 606, otherwise the SIMPLET value is added to COMPLET, the timestamp is reset 612, and TS waits for the next SIMPLET 611.

If a COMPLET of a certain Category j/Locality L does not exist 602 then TS will initiate a new COMPLET of category j, locality L 607. (If the Locality is not relevant or important for a particular commodity category TS system will automatically initialize the locality to a default value.) TS adds the value of a SIMPLETᵢ to the new COMPLETⱼ 608. If the total value of the resulting COMPLET not exceeds the maximum, TS will wait for the next SIMPLET 609, resetting the timestamp to Time 0, to be able to continue increasing the COMPLET size 612. TS compares the value of a $COMPLET to the minimum value adjusted by Statistical Complet Analyzer 611. If a total $COMPLET value exceeds the maximum TS stores COMPLET data and releases it to the bidders 605, 606.

An important task of the COMPLET generation software as a part of TS is to determine the total risk. TS calculates Risk at steps 604, 608, and 612 based on two different risk categories. Risk as considered by the Commodity Provider that bids on a COMPLET consists of two parts. The first risk is Consumer's Risk that is associated with the possibility of the customer's default on his obligation to purchase “commodities” over time. This Risk is in fact credit risk. The Consumer's Risk for every SIMPLET in the generating COMPLET is calculated and stored in the SIMPLET object at the time of SIMPLET generation.

The second risk is associated with the nature of commodities business, i.e. Industry Risk. Some of the commodities defined in this patent are highly volatile in price and profit margins for producers and resellers. Consider two examples, food and energy (oil, natural gas) prices. Since profit margins of the companies that bid on a COMPLET define the extent of the wholesale discount the Commodity Provider could offer, it is important to include Risk as a data member into a COMPLET object.

An average Risk is normalized to 10, i.e. it has range of 1 through 10. As was said above the Rate % depends on the risk. The Risk is tabulated by the Commodity Providers, and consumer Risk of default is rated by the Credit Ratings agencies. The total Risk may be expressed as:

Risk=(Riskᵢ*$SIMPLETᵢ)/$COMPLET+Industry Risk*Time Risk

where Riskᵢ i is consumer's Risk for the ith SIMPLET of worth $SIMPLETᵢ, and where Risk is the sum all the Risks over N SIMPLETs (from 1 to N), where N is the total number of SIMPLETs in the COMPLET.

Since the customer's risks differ, one calculates Risk with SIMPLET worth normalized by the total worth of the COMPLET. The length of the contract determines Time Risk since the longer the time term of a contract the larger volatility of the particular commodity price and commodity providers' profit margins. Industry Risk is tabulated, depends on the Commodity Category, and is estimated for each particular case.

Depending on the Risk the minimum bid will be adjusted. For example, for the particular COMPLET worth $140,000.00 and Risk=9, the initial minimum bid is $19,900.00. If the Risk changed to 3, the initial minimum bid is adjusted to $14,000.00 total. The initial formula for the initial minimum bid calculation is:

$initial minimum bid=Base minimal bid*(1+Risk/10) (3).

Base minimal bid is tabulated for each category.

Each COMPLET is encrypted using a public key encryption algorithm (RSA or PGP), while each SIMPLET is symmetrically encrypted.

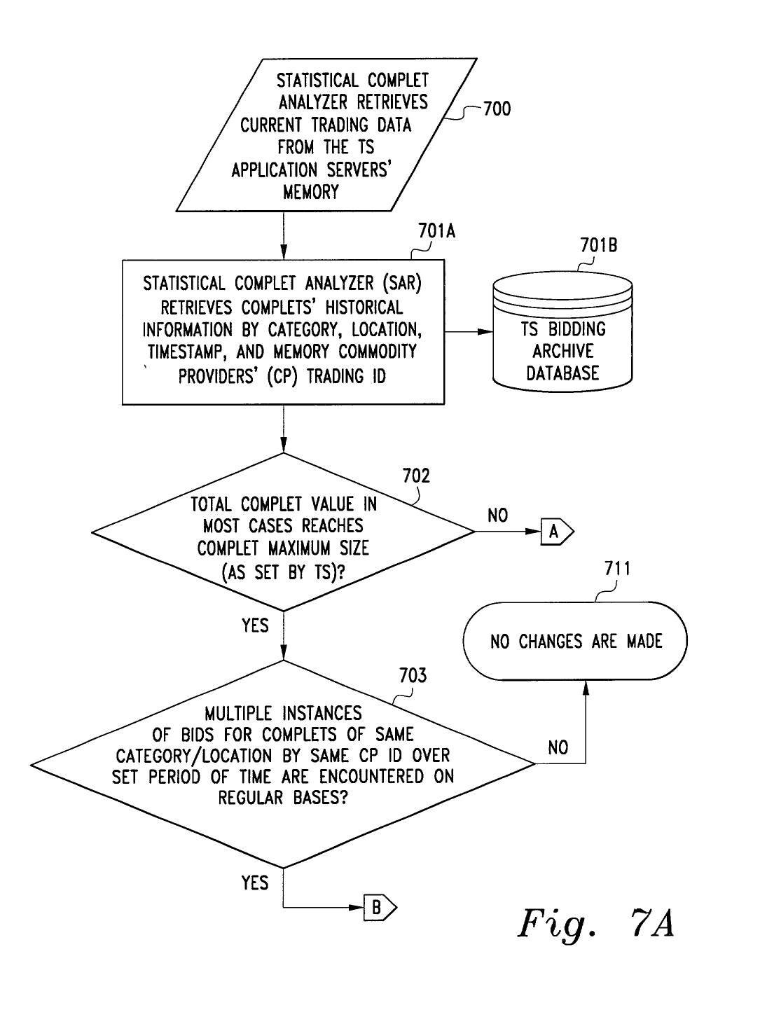

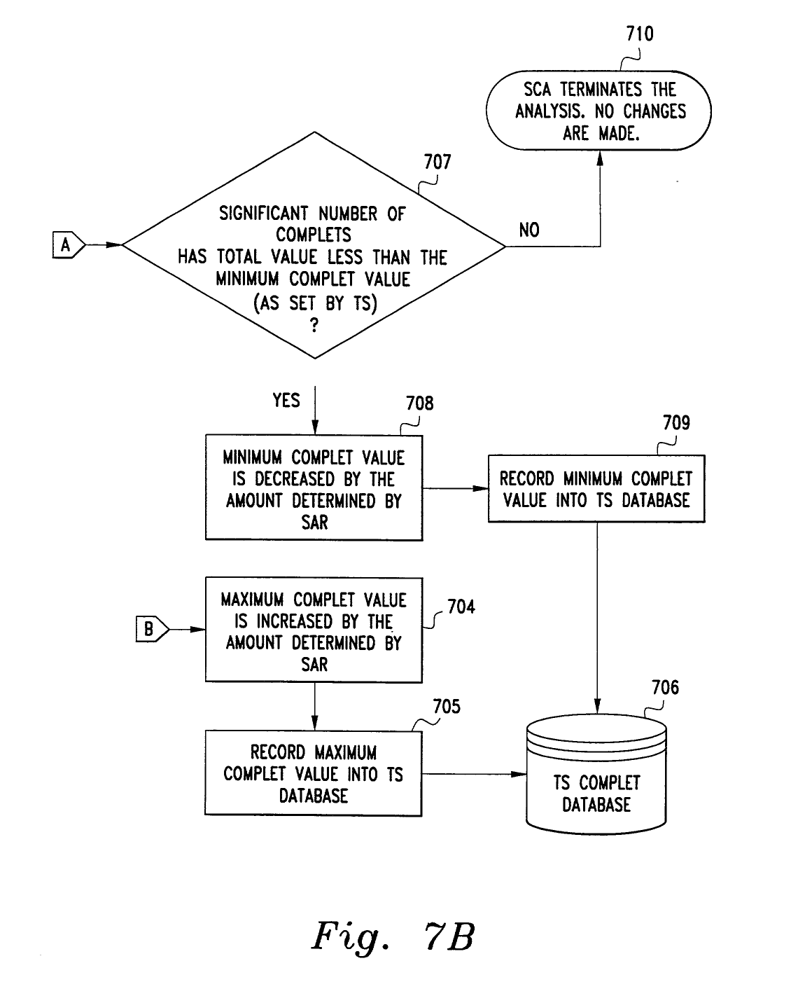

FIGS. 7A-7B illustrate the Statistical Complet Analyzer (a.k.a. SCA) Algorithm implemented in TS application software. The algorithm, which is based on history data of particular category trades stored in the TS Bidding Archive Database 701B, adjusts the maximum or minimum of the total monetary size of COMPLET objects to be auctioned. The adjustment is done to better adapt to commodity bidders' demands.

The best implementation of SCA software is a neural network trained on the trading history data. Here Neural Network is a statistical software package that will increase the $Cmpmax (maximum allowed $COMPLET value) when demand from Commodity Bidders for the particular size COMPLET objects of a particular category is high, and decrease $Cmpmin (minimum allowed $COMPLET value) when the demand from bidders is low.

As described below, the high demand is determined by querying bidders' IDs. If a high percentage of the bidders buy multiple COMPLET objects of the same category (Cmpᵢ of Catⱼ), SCA will proportionally increase $Cmp size (see formula below). For each commodity category, location, and time, Complet Analyzer retrieves recent trading data from TS Bidding Archive Database 701 and looks up current trading data from TS Application Biddings Servers Memory 700. First, Complet Analyzer checks if total COMPLET values in most trades (for a certain period of time) reach current COMPLET maximum size (dollar value of the COMPLET) as set up by the TS 702. If not, and no significant number of COMPLETs have total value smaller than the minimum COMPLET value, SCA will terminate the adjustment process 710. If yes 707, SCA will decrease minimum COMPLET size 708, so more COMPLET objects can be auctioned. SCA stores the new minimum COMPLET value 709 (interchangeable with word size here) in the TS COMPLET Database 706.

If the number of bids is significant 703, i.e. bidders demand is significant; SCA will increase maximum COMPLET size 704 and record 705 the value in the COMPLET database 706. Thus, the SCA mechanism allows TS to adapt to changes in the bidders demands for each particular COMPLET category. The optimal COMPLET size from bidders perspective, as well as TS Owner's view varies with time.

The following formulas describe the adjustment value for maximum and minimum COMPLET size adjustment. The process starts with the base size of the COMPLET $Cmp Baseₘₐₓ (the base COMPLET maximum value tabulated by TS and stored in the TS Bidding Archive Database 701B).

$Cmpmax=(Nbid_{id}/TotalN)*$Cmp Baseₘₐₓ (4)

$Cmpₘₐₓ=$Cmp Baseₘₐₓ+$Cmpₘₐₓ (5)

$Cmpₘᵢₙ=$Cmp Baseₘᵢₙ−$Cmpₘᵢₙ (6)

$bid price=$bid priceₘᵢₙ−$bid price (7)

$bid price=$bid priceₘₐₓ+$bid price (8)

where Nbidid is the percent number of bids that have the same bid ID, TotalN is the total number of bids, $Cmpₘₐₓ is the dollar value adjustment determined by the Neural Net, $Cmpₘᵢₙ is the minimum allowed COMPLET value, is the base COMPLET minimum value, $bid price is the bid price increment determined by the TS, and $bid priceₘᵢₙ and $bid priceₘₐₓ are the minimum and maximum bid prices set up by the TS for a particular commodity, respectively.

Thus, bidding prices ($bid price) are adjusted. The bidding price is the initial minimal price TS asks for the COMPLET. It is obviously different from the COMPLET size $Cmp, that is, it is larger. $Cmpₘₐₓ is maximum size of a COMPLET, while $Cmpₘᵢₙ is minimum size of a COMPLET.

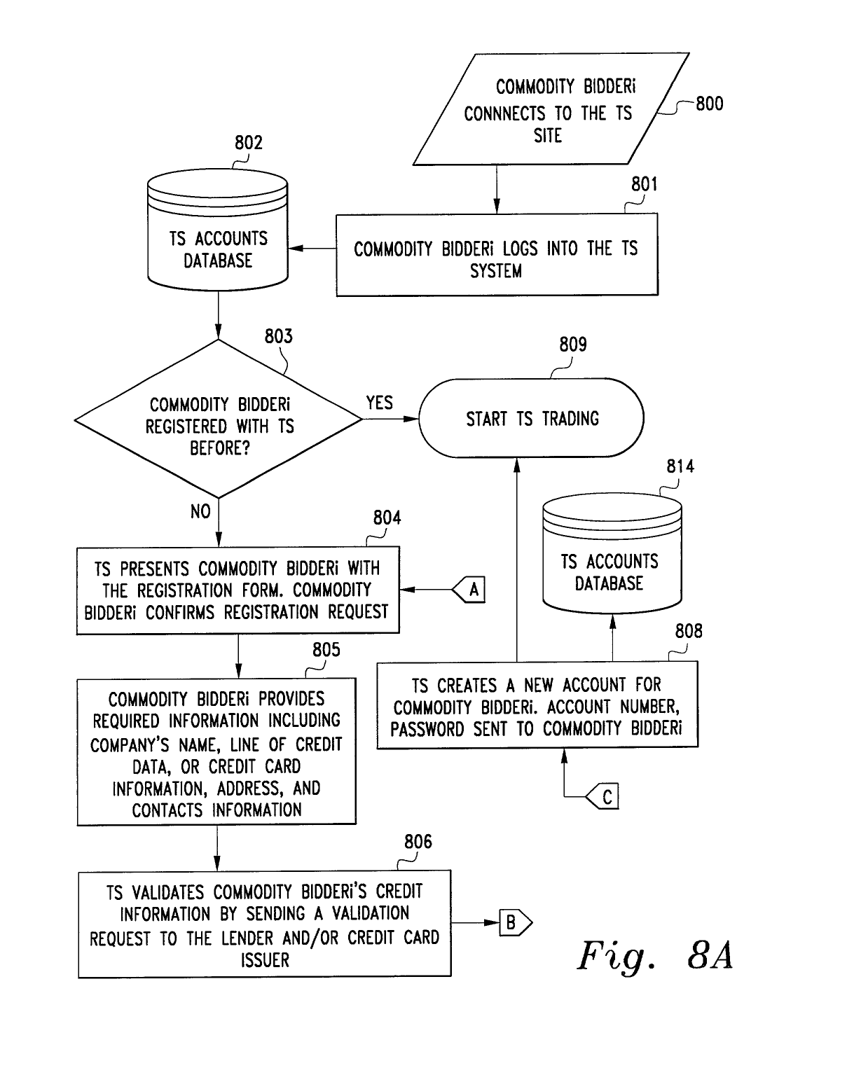

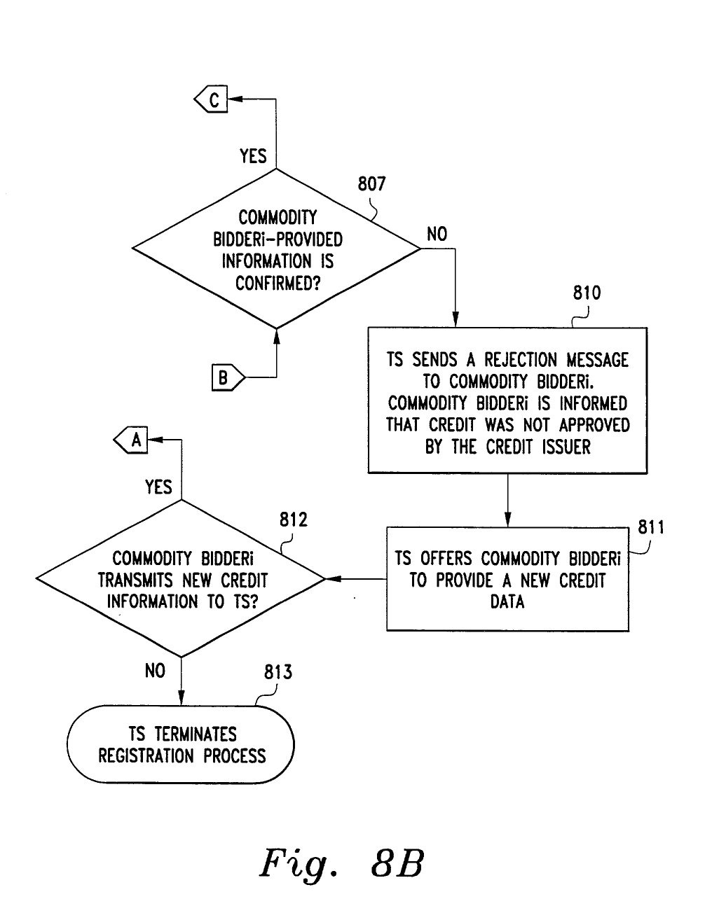

FIGS. 8A-8B illustrates the registration Process for Commodity Providers. Before starting to bid commodity providers have to register with the TS Owner. We will use the term Commodity Bidder from here on (basically, Commodity Bidders are Commodity Providers that decide to participate in the TS auction). After Commodity Bidder connects to the TS registration site 800 it will enter its login name and password (if it's manual trade) 801. TS will validate Commodity Bidders 803 against TS Accounts Database 802. If Commodity Bidder registered before and his line of credit is valid, TS allows Commodity Bidder to start trading 809. If not, TS presents the Commodity Bidder with a registration form 804, Commodity Bidder provides the requested information 805, and the TS validates the Bidder's credit information by inquiry to the lender or other financial institution 806. If the Bidder information is confirmed 807, TS creates a new account 808 and stores information on the new Commodity Bidder in the TS Account database 814. Otherwise, TS sends the Bidder notification that his credit was not approved 810 and offers the Bidder the opportunity to submit new credit information 811. If the Bidder sends new credit information 812, the validation process is repeated, otherwise the registration process is terminated 813.

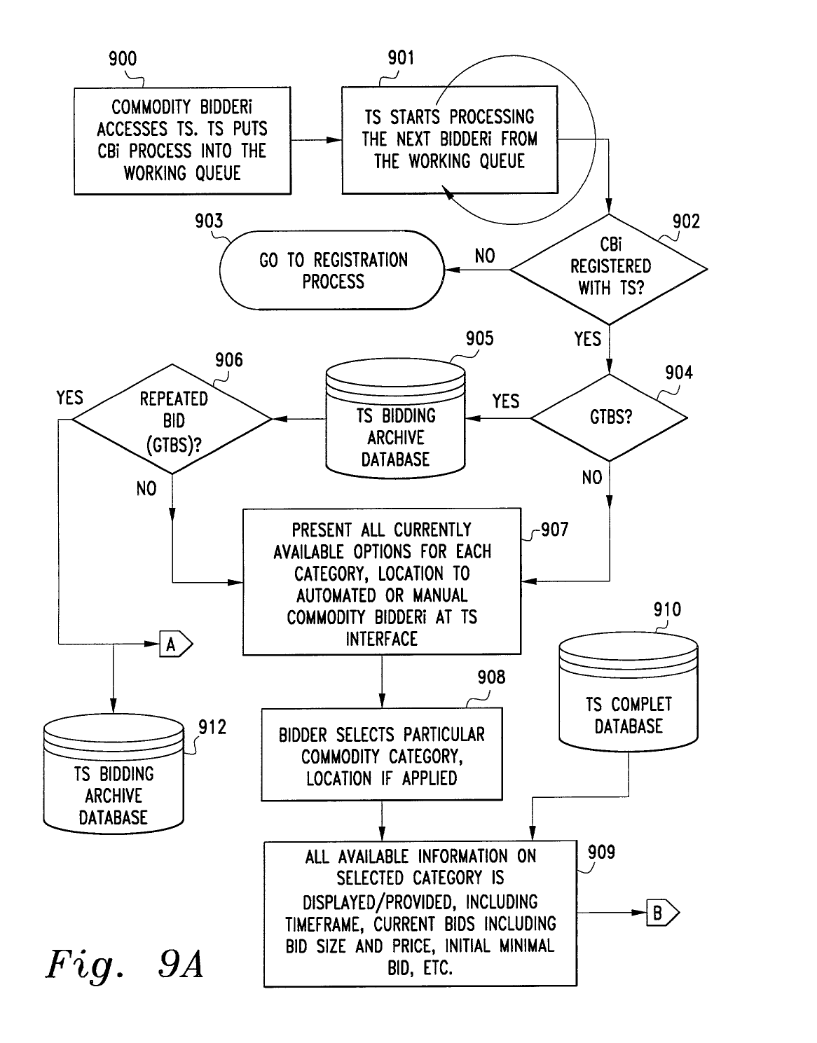

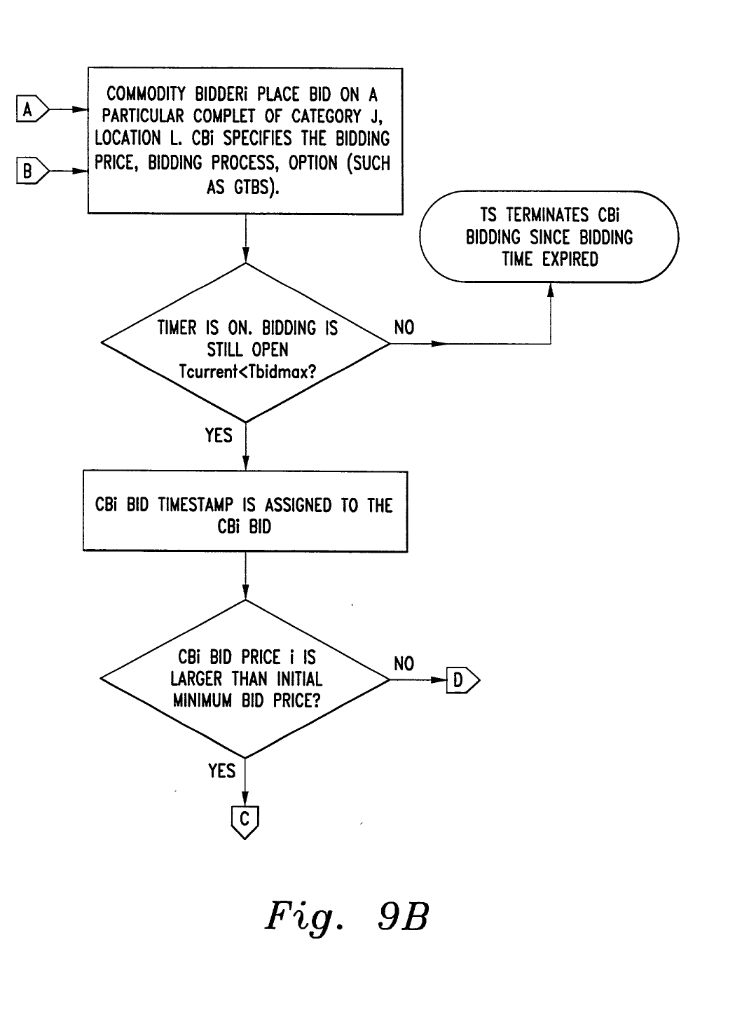

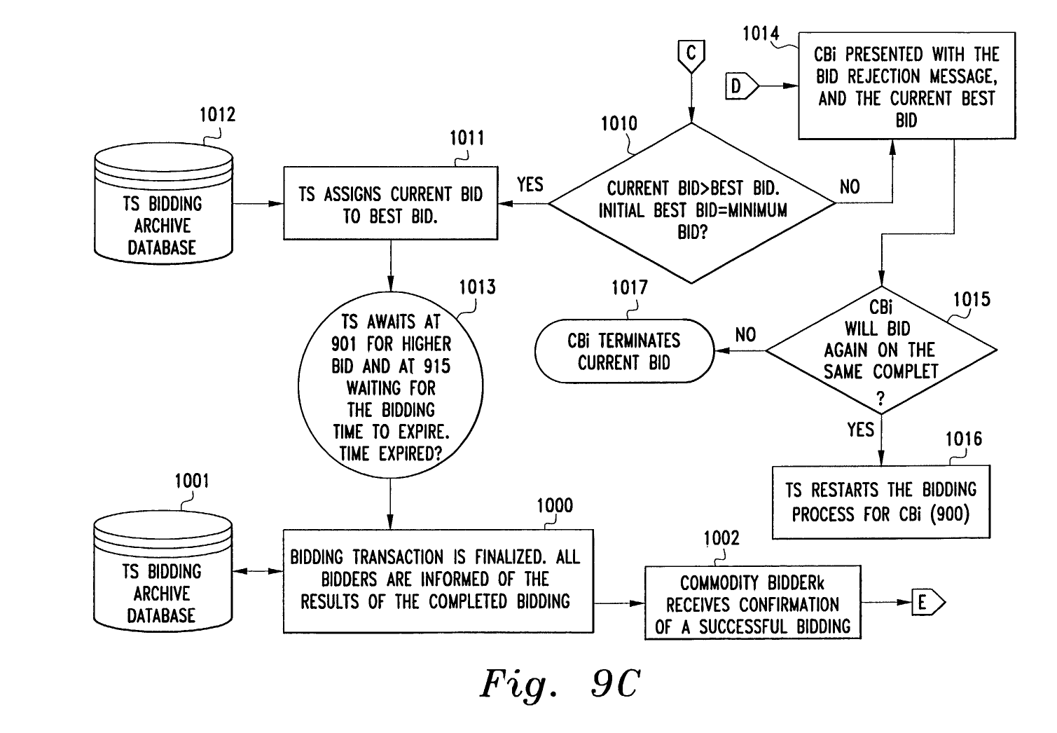

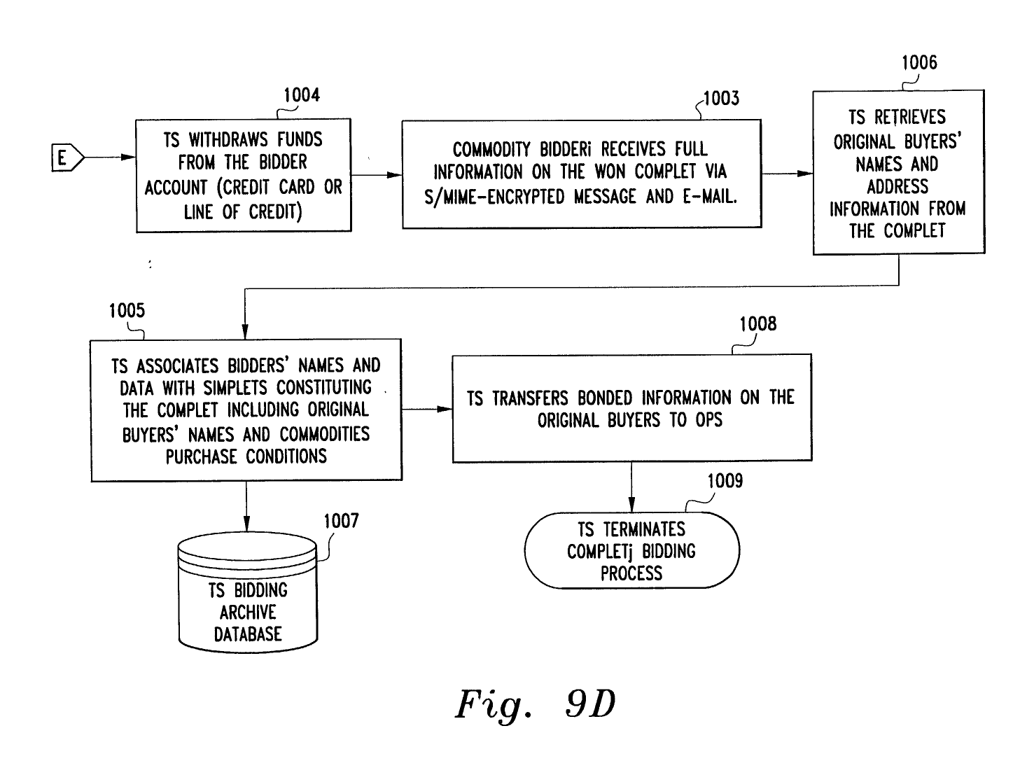

FIGS. 9A-9D describe the logic of the TS bidding process where the Commodity Bidders are the Commodity Providers and the seller of the bundles of contract options is the TS Owner. TS Application software is implemented as Java servlets (though other implementations are feasible) running business logic on the TS Application server set. All interactions with Commodity Bidders (another word for Commodity Providers) are conducted via HTTP/HTTP(S) calls at port 443 (SSL sockets). Transmitted data between Commodity Bidders servers and TS Owner's servers are described with XML, embedded in HTTP calls. All transmissions are conducted over SSL (Secure Sockets Layer, the leading security protocol on the Internet.

All important transmissions between Commodity Bidders and TS are public key encrypted (RSA[Rivest-Shamir-Adleman, a highly-secure cryptography method developed by RSA Data Security, Inc. of Redwood City, Calif.] or PGP[Pretty Good Privacy, a public key cryptography software from Pretty Good Privacy, Inc. of San Mateo, Calif.]). When the TS web server 304 interacts for the first time with a Commodity Bidder, it will issue a digital certificate to the Commodity Bidder. Thus, when Commodity Bidder's automated bidding software located on Commodity Bidder's server connects to TS Owner's server 304 it presents a digital certificate that was issued by TS server previously. TS server confirms the nature of the Commodity Bidder running the presented digital certificate against TS Accounts Database 308. It will also validate another digital certificate issued by the third party (example, VeriSign). TS Server Application Software exchanges data with Commodity Bidder's application server via XML-described data sets over HTTP and HTTP(S) calls on 443 port.

Commodity Bidder i (CBᵢ) accesses TS 900. As was commented previously, Commodity Provider of the COMPLET category j that would like to “acquire” multiple customers in that category becomes a Commodity Bidder. The purpose of the bidding is to purchase a COMPLET worth $COMPLET as was generated previously (FIG. 6) for the dollar amount exceeding or equal to the initial minimum bid (minimum $Complet price) posted by TS. As was noted before, the initial minimum bid for the particular COMPLET is set up by TS. TS uses calculated Commodity Rates stored at TS COMPLET Database 307 to establish the initial minimum bid. TS uses profit margins, wholesale vs. retail average historical prices tabulated at the TS COMPLET database 307, and estimated RISKS to calculate RATEj for a particular COMPLET category j, as well as Location L. Customer's risk of default is calculated separately at the time of SIMPLET generation (409, FIG. 4-5).

Commodity Bidder (CBᵢ) trades via TS using manual and/or automatic modes. (1) Connection to the TS web site is done manually by the CBᵢ personnel connected to the TS Owner's site via common commercial browser software (for example, MS Internet Explorer) or with a proprietary browser. (2) Another way of TS access is with Automated Software Web Application. In both cases TS puts CBᵢ into the bidders working queue 901. After processing other CBᵢ₋₁ in queue, TS starts processing the ith bid from the working queue.

TS verifies that CBᵢ is registered with TS 902. This is done by running a CBᵢ-provided identifier (login name and password) against the TS Registration database 801. If CBᵢ has not registered with TS before, TS System starts registration process (903, 800). If CBᵢ registered with TS before, the bidding process continues. TS creates a CBᵢ working object for this particular bidding. (The CBi bidder object is built/created at the registration and reinitialized at login bidding time. When the bidding process starts, the CBᵢ current bid working object (CBᵢ) is created with bidder ID field filled with login name. Other CBᵢ data members are initialized with data retrieved from the TS Registration database [query is done by bidders login name].) CBᵢ selects a bidding type, for example “Good till bidding succeeds” 904 (a.k.a. GTBS). After that action TS records the bidding type in TS Bidding Archive Database 905.

There can be a number of bidding types, including “Good till the end of trading day” (a.k.a. GTED) and “Market order”, i.e., an order that is good only for one bid.

After recording the bidding type 905, TS determines if this is repeated bid (GTBS) 906 waiting in the system since the previous COMPLET bidding. TS determines the bidding type by checking GTBS_stat data member 906 in the CBᵢ working object. GTBS_stat value is BOOLEAN. It is assigned a TRUE value when the bid is a repeated GTBS bid. If the CBᵢ bid is not a repeated bid, TS presents CBᵢ with all currently available options for each category 907.

The current bid ID for the CBᵢ is generated and assigned to the CBᵢ instance, i.e., the current bid working object. The number of CB instances for the particular Bidder ID running at the same time is not limited, i.e. each Commodity Bidder may bid for multiple COMPLETs at the same time.

After all current bids categories are presented to CBᵢ 907, CBᵢ selects particular commodity category and Location, if applicable 908. For example, for the electricity provider, it is very important to consider Location of the customer in addition to the category selected (multiple electricity sellers are possible due to the market deregulation). If the original bidder's Location information is not important this Location data member is defaulted to the default Location value.

TS presents (displays for manual interaction or provides data for automated interaction) all available public COMPLET interface data for the selected category and location. There can be multiple COMPLETS presented for the selected category/location at the same time. The presented Information contains the timeframe of the COMPLET bid, descriptions of all current bids, Bids size and Price, Total Time Of the Original Buyers′ Commitment, Initial Minimal Bid established by TS Bids Analyzer 909. Bid size is the particular COMPLET worth in purchase options, i.e. how much goods and services the customers committed to purchase over the defined time period. Bid Price is the current best price that bidders are willing to pay for the COMPLETⱼ.

Total Time of the Original Buyers′ Commitment is the time period over which the original buyers will be purchasing selected goods and services. TS retrieves COMPLETⱼ data from the TS COMPLET database 910 running on the TS Database servers/mainframes. At 911 CBᵢ places a bid via secure connection on a particular COMPLET of category j and location L. The application server 306 captures bid data where TS resides in the server sets' memory. Bidder CBᵢ specifies the following data: CBᵢ bidding price and Bidding Process option (GTBS or NOT) 911.

Before continue with the bidding process for CBi, TS bid processing subsystem determines if the current bid is still open by comparing system time value against maximum bidding time (914). TS defines the time limits for each bidding. If T_{current}<Tbidₘₐₓ then TS generates a timestamp for CBi's bid. TS assigns the generated timestamp value to CBᵢ object's Timestamp data member 915. If T_{current}>=Tbidₘₐₓ then TS terminates the CBᵢ bidding transaction 917. The transaction record is saved at TS bidding database 912 and will be kept there for certain period of time.

While bidding continues TS determines if the CBᵢ Bid Price exceeds or equal initial minimum bid price setup by the System 916. If CBᵢ's bid is less than the initial minimum bid price then TS sends a notification message to CBᵢ requesting a better bid 1014. If CBᵢ will not bid on this COMPLET, TS terminates the CBᵢ bidding 1017. If CBᵢ offers a better bid 1015, TS restarts bidding process for CBᵢ 1016.

If CBᵢ's Bid Price exceeds the initial minimum bid price and is better than best bid (current best bid) 1010, TS assigns current CBᵢ bid to best bid 1011. This incomplete transaction will be temporarily stored in TS Bidding Archive Database 1012. TS enters into waiting state 1013. TS waits for a better bid on the COMPLET. If the bidding time expires and no better bid was presented, TS finalizes bidding for this COMPLET 1000. TS records the winning bid transaction information into the TS Bidding Archive Database 1001. TS informs all bidders via HTTP(S) calls over SSL line or by S/MIME e-mail or by any other electronic means of the results of the bidding 1002. CBᵢ receives an encryption key for the FULL access to the COMPLET data via secure line (SSL) 1003, including access to the incorporated SIMPLET data. Encryption is implemented via public key infrastructure technology. The private key and COMPLET are sent over S/MIME e-mail.

The second possibility for CBᵢ to access a won COMPLET object is to connect to TS Application Server 306 using the digital certificate issued previously. TS then transmits COMPLET data over SSL line, public key encrypted. The private key for SIMPLETs will be sent or accessed separately via S/MIME e-mail or directly via PKI access.

CBᵢ now has full information on the contracts that constitute the COMPLET. The data includes full customer information, including Name, Billing Address, Credit Card Number, Expiration Date, Name on the Credit Card, Date of Commitment to purchase commodities, Customer's RISK of default (Credit Rating), Time Frame on the contract.

TS withdraws funds from the CBi account 1004. There can be a number of CB methods of payment. One of them can be credit card account. The Commodity Bidder prior to the bidding provides a Credit Card Number, Expiration Date and Name on the Account. Then TS withdraws funds from the Credit Card Account 1004. Another Account implementation for an online transaction is a prepaid web account. In this particular case TS withdraws money from the web account when the bidding is completed 1004. A third way of payment is a prepaid TS account, when the Commodity Bidder provides funds to the TS Owner prior to the bidding. TS withdraws funds in the amount of the winning bid from the TS bidders account 1004.

TS retrieves Original Buyers Names and other relevant information from the sold COMPLETⱼ 1006. Then TS associates Commodity Bidder's Name and other Commodity Bidder's data with the SIMPLET objects constituting the sold COMPLETⱼ 1005. The resulting associated data is stored at TS Bidding Archive Database 1007. TS transfers associated data to the OPS subsystem of the dual OPS/TS system 1008 where the names of the winning bid Commodity Bidder is also stored. TS then terminates the COMPLETⱼ Bidding Process (1009).

FIG. 10 illustrates the TS Bidders-Buyers Association algorithm. Since only COMPLET objects are traded on the TS, the System has to correctly relate each Original Buyer with the particular Commodity Bidder that won the bid on the COMPLET containing Original Buyer's contract. The TS dual system must forward information on the winning Commodity Bidder to the Original Buyer whether Commodity Buyer contacts the Original Buyer or not. Since there can be multiple SIMPLET objects for each original transaction by the original Buyer (i.e. Original Buyer committed to purchase more than one commodity at the time of the first purchase) , there may be multiple messages to the Original Buyer from the TS.

TS starts the association process at 1006. The details are shown starting in FIG. 10 at 1100. First, TS retrieves the Bidder ID from the application server memory and assigns Bidder ID to the sold COMPLET 1101. TS records the Commodity Bidder's name into TS COMPLET Database 1102. TS retrieves SIMPLET IDs from the sold COMPLET. TS creates association pairs (Bidder ID, Simplet ID) 1103. TS subsystem of the dual OPS/TS system transfers the created pairs to OPS 1104. The OPS subsystem records Bidders IDs 1106 to the correct SIMPLET records, identified by SIMPLET IDs, in the OPS SIMPLET Database 1105. The OPS sends an electronic message with Commodity Bidder's information to the Original Buyer 1107. OPS terminates the complete purchasing process 1109.

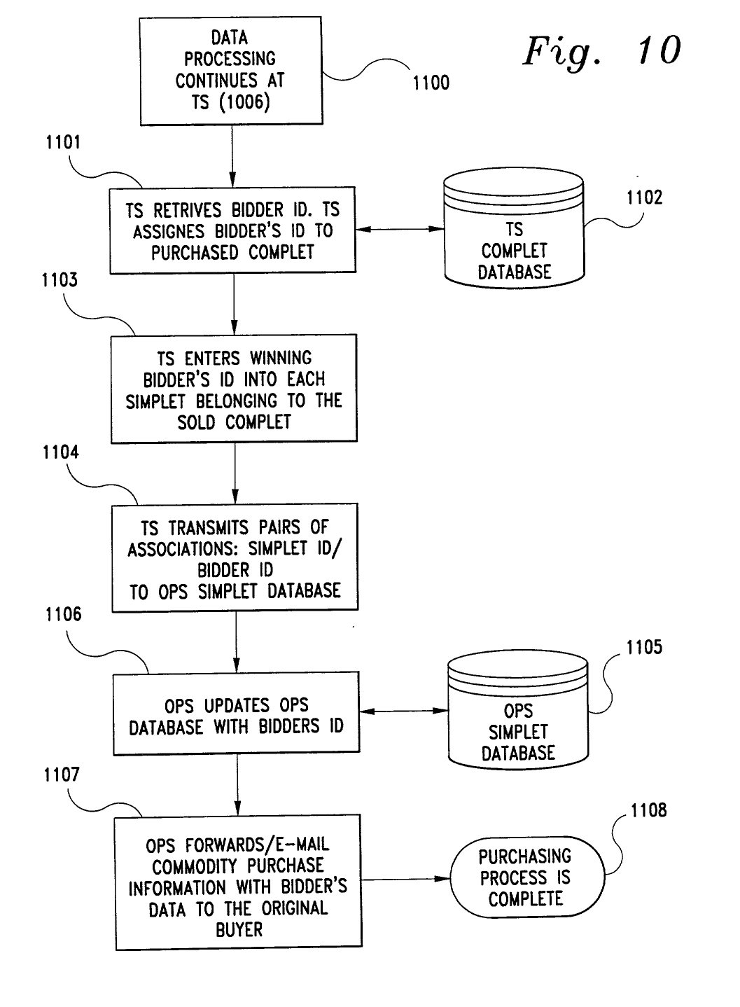

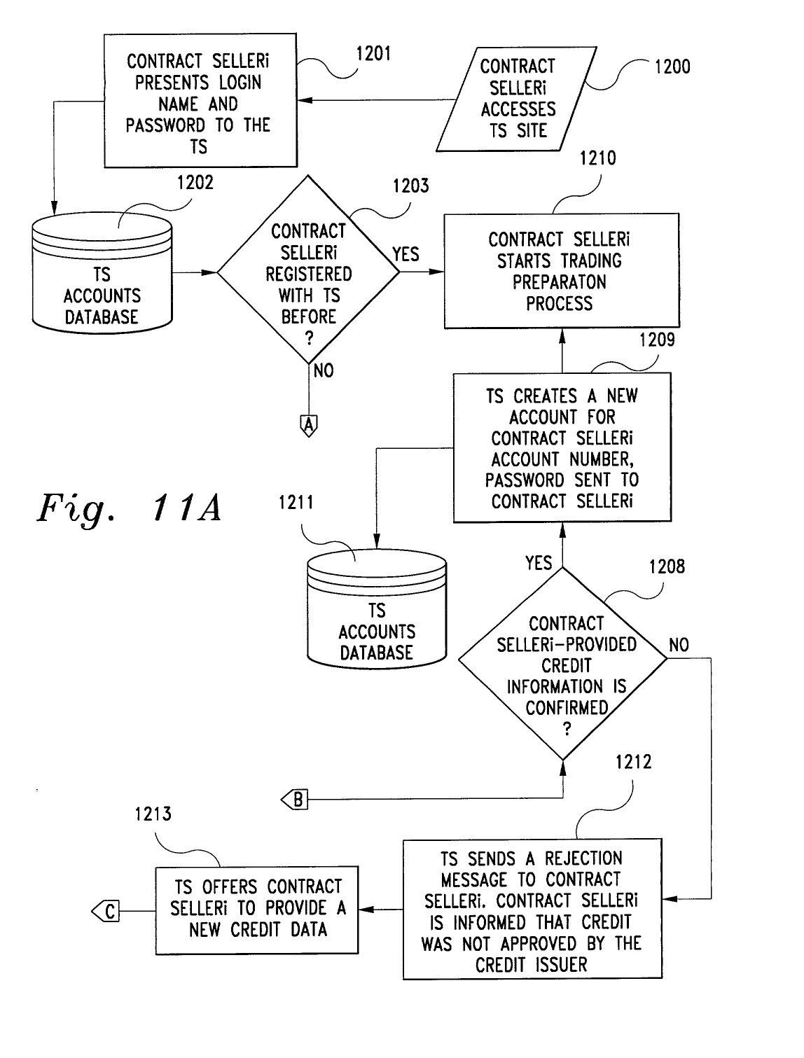

FIGS. 11A-11B illustrate the registration process for the Commodity Provider (Contract Seller) . There are situations when Commodity Provider would like to sell commodity contract options it purchased previously using TS system. For example, Commodity Provider could exit a particular market or stop providing services in the particular area. In cases like those Commodity Provider might sell a number of COMPLET objects in full, or the time remaining on the COMPLET up to the time limit. For example, some of the customers already purchased 30% of their contract obligations by the time the Commodity Provider decides to sell the contracts. We will use the term Contract Seller instead of the Commodity Provider in discussing FIGS. 11A-11B.

In all cases, to trade on TS, Contract Sellerᵢ must first register with TS Owner. First, Contract Sellerᵢ accesses TS 1200. This is done via Internet Connection or Virtual Private Network connection or by other electronic means. Contract Sellerᵢ provides login name and password, or any other seller's ID 1201. TS validates the presented login data against TS Accounts Database 1202. If Contract Sellerᵢ already registered with TS system to sell contract options 1203, TS refers the Contract Seller to the Trading Preparation Process 1210. If Contract Sellerᵢ is not registered with TS, TS presents Contract Sellerᵢ with the Registration Form 1204.

Contract Sellerᵢ starts registration 1204. Contract Sellerᵢ provides required information including Company's Name, Old Commodity Bidder ID, and password under which initial purchase of the COMPLET for sale occurred 1205. TS opens a new aftermarket contract sales account, and the record is stored in TS Accounts Database 1216. Contract Sellerᵢ also provides means of payment, as well as bank account information 1205. Bank account information is important since after trading TS will deposit funds in the amount of the winning bid minus the handling fees.

Contract Sellerᵢ presents Commodity Category information, Locality, amount of time to commitment expiration left and total COMPLET value left 1206. The new working object Contract Sellerᵢ is created and data members are initiated at the Application Server Set level after all the data is sent by the Web Server. TS validates the Credit or Bank Account or prepaid Web account information 1207.

After successful confirmation 1208 of all submitted information, TS records all the data in TS Account Database 1211 and terminates the Registration Process 1215. TS Registration subsystem sends new account number and password via secured line 1209.

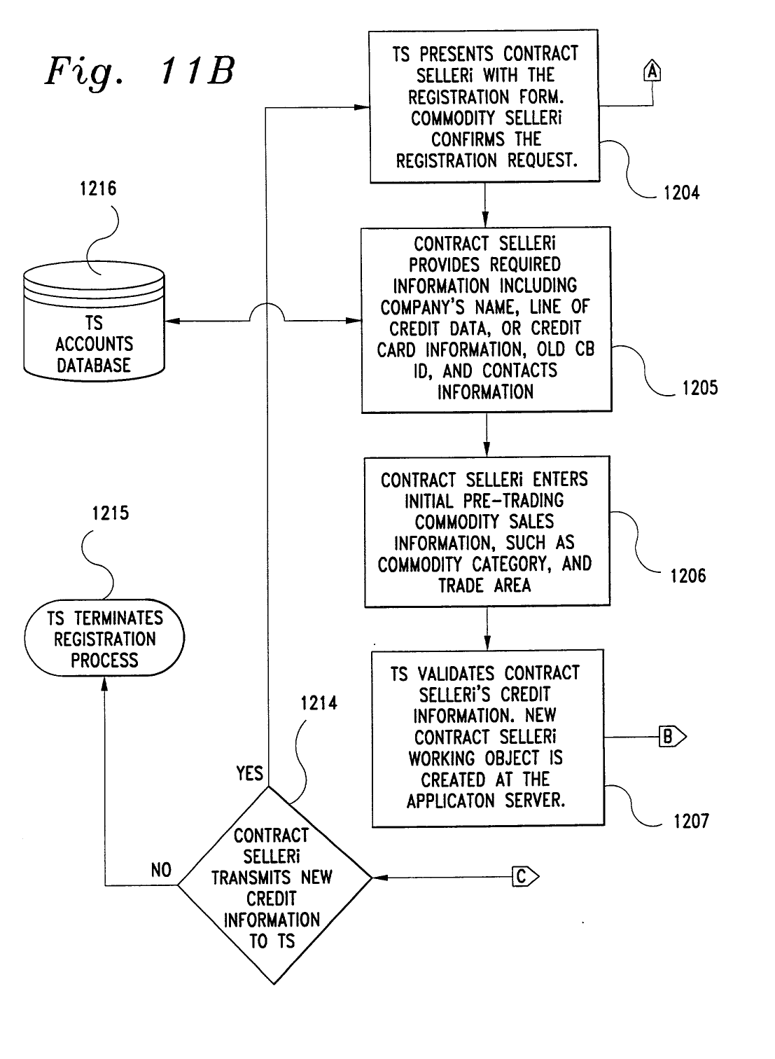

FIG. 12 details a Contract Options Trading Preparation Process. The purpose of this process is to collect the COMPLET information that Contract Seller puts out for sale. After Contract Sellerᵢ initiates the trading preparation process 1210, 1300, TS prompts Contract Sellerᵢ to provide COMPLET information for planned trade in a particular category j and location L (1301). Contract Sellerᵢ provides requested information, including Current Worth of COMPLET (contracts bundle), how many unfulfilled contracts left, all individual information on the SIMPLET contracts in the bundle, all contract length and other contract information 1302. Application Server 306 creates new working object COMPLETⱼ to use for the coming online auction. Application Server 306 initializes COMPLETⱼ with Contract Sellerᵢ IDs that became available when Contract Sellerᵢ accessed TS at 1300 and at the time of registration 1200.

Web Server 304 captures presented COMPLETⱼ information 1302 and sends it to the TS Application Server 306. TS Application Server initializes data members of the newly created COMPLETⱼ working object with available COMPLETⱼ information. TS validates provided COMPLETⱼ information 1305 against TS Bidding Archive Database 1306. Basically, TS verifies that COMPLETⱼ was sold to Contract Sellerᵢ. TS accepts the provided information on COMPLETⱼ 1304. Then TS converts provided contract options data for COMPLETⱼ into new trading COMPLETₘ 1307. TS stores information in the TS Complet Database 1309. Finally, TS presents new COMPLETₘ for trading 1308. If at 1304 TS is unable to accept the provided information on COMPLET_{J}, then the TS notifies the Contract Sellerᵢ of the failed verification and prompts the Contract Sellerᵢ for correct information 1303. After three failed attempts 1310, the TS records the failed attempts 1311 in the TS Bidding Archive database 1306 and terminates the trading preparation process 1312.

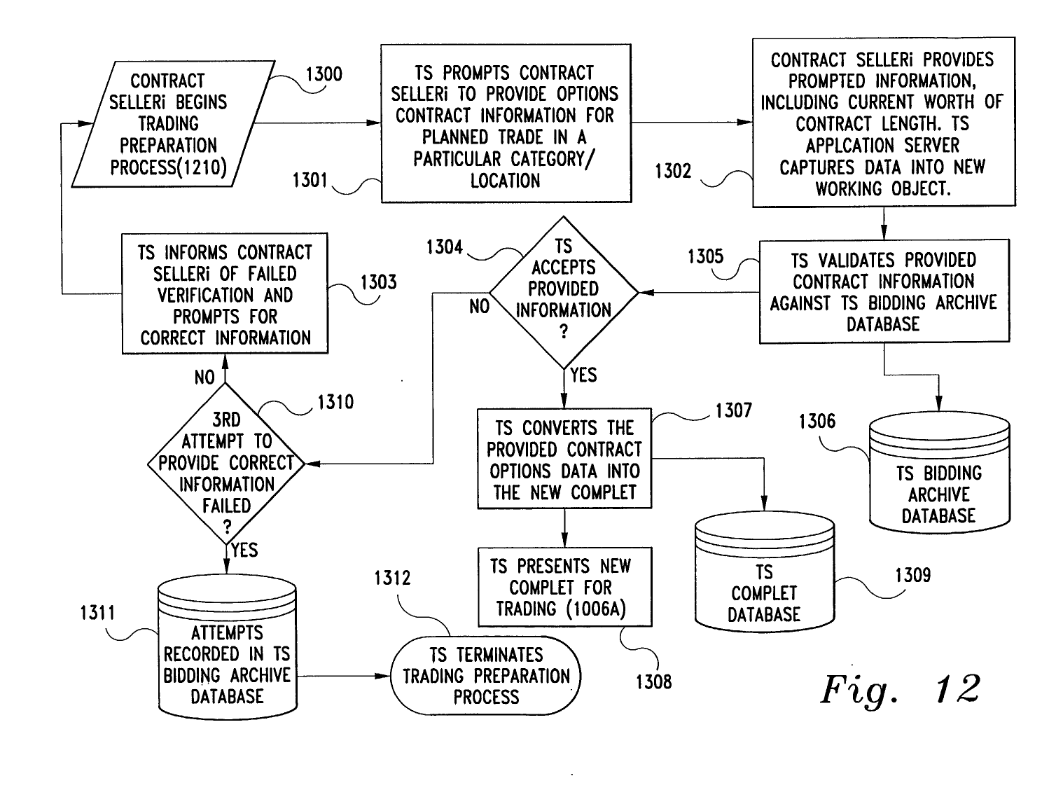

FIG. 13 details a Retail Kiosk architecture overview of the Trading System. TS Retail Kiosks are located at the brick-and-mortar retail stores 1400. There are two possible implementations of the said Kiosks depending on whether the merchant allows TS Owner to connect a store-located kiosk directly to it's network. In both cases the Retail Kiosk architecture provides for displays for the buyer and has proxy browser-enabled TS software that is connected to the TS application servers (and thus has full TS capabilities and most features) and the merchant's central application server 1401 and merchant's database 1402.

In the first implementation, the Retail Kiosk 1400 is a PC-based computer system that connects via LAN or WAN to the retailer's central application server 1401, that in its turn is connected via secure Private Virtual Network or Internet to the merchant's database 1402. One or more Commodity Providers 1412 are also connected to the network. The merchant provides the capability of connecting its central application server 1401 to the TS servers 1404 and 1405 or 1410, 1409, and 1408 via Internet or virtual private network, and consequently the Order Process System database 1406 and Trading System database 1407.

In a different variation, multiple Retail Kiosks could be installed at the brick and mortar site (for example, a mall). There will be a TS application server connected to the multiple Retail Kiosks 1400A. In this modification, the Retail Kiosk is a dumb terminal connected to the locally installed server by wire or wirelessly. In it's turn TS server 1412 will be connected via LAN/WAN to the original merchant's application server 1401 and, thus, to the merchant's database system 1402.

In second implementation, TS Retail kiosk is wirelessly connected to TS remote server 1411. In it's turn, TS remote server 1411 is connected to the Merchant's application server 1401 via Internet (or Private virtual network). TS remote server 1411 has a local copy of the OPS database, containing OPS accounts information, list of all commodity categories, commodity providers names to decrease network traffic.

TS Retail Kiosks enable the TS implementation via collaborative interaction with the Retailer's application (business rules) servers and databases.

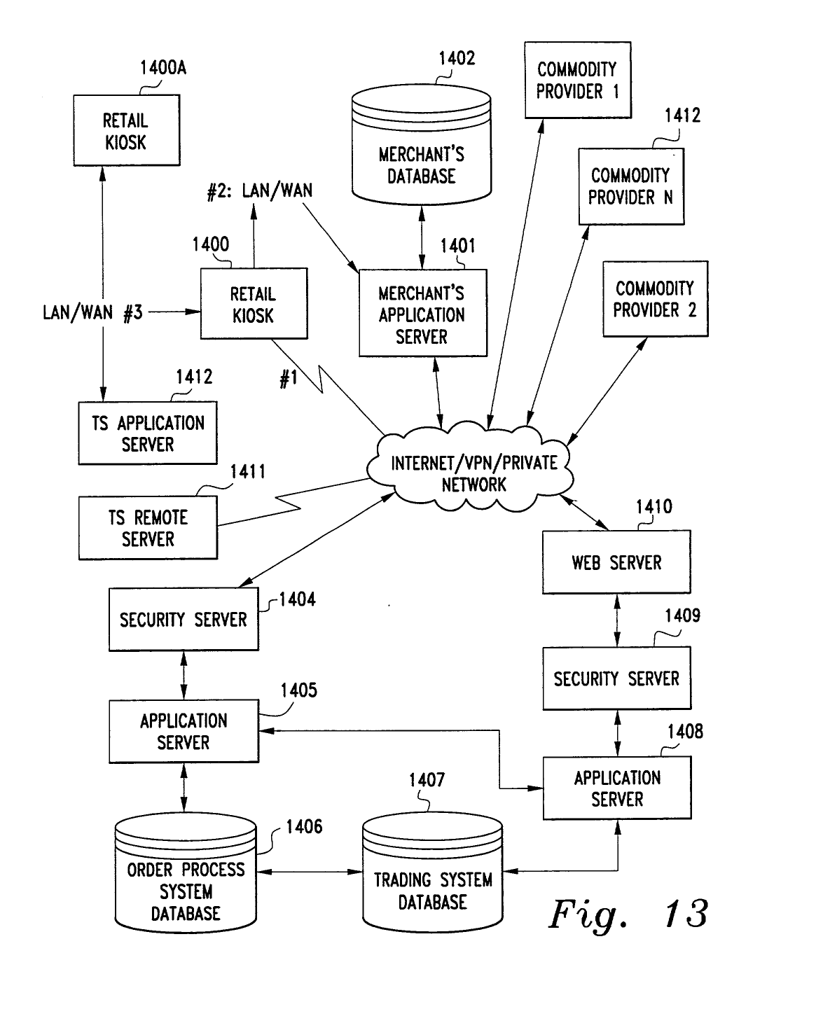

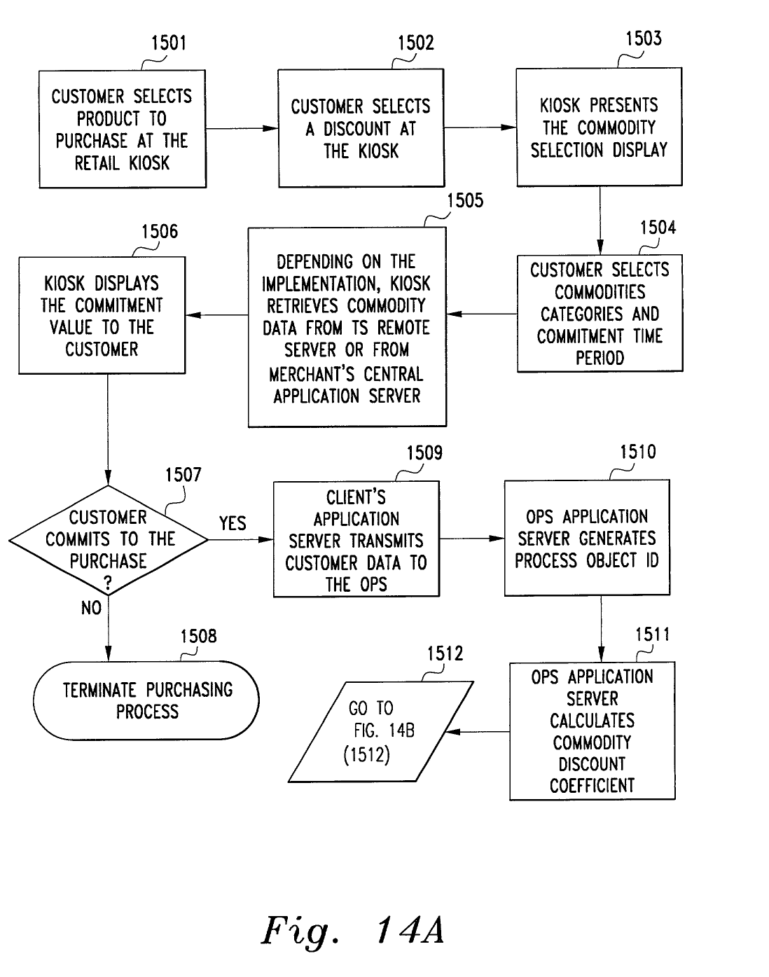

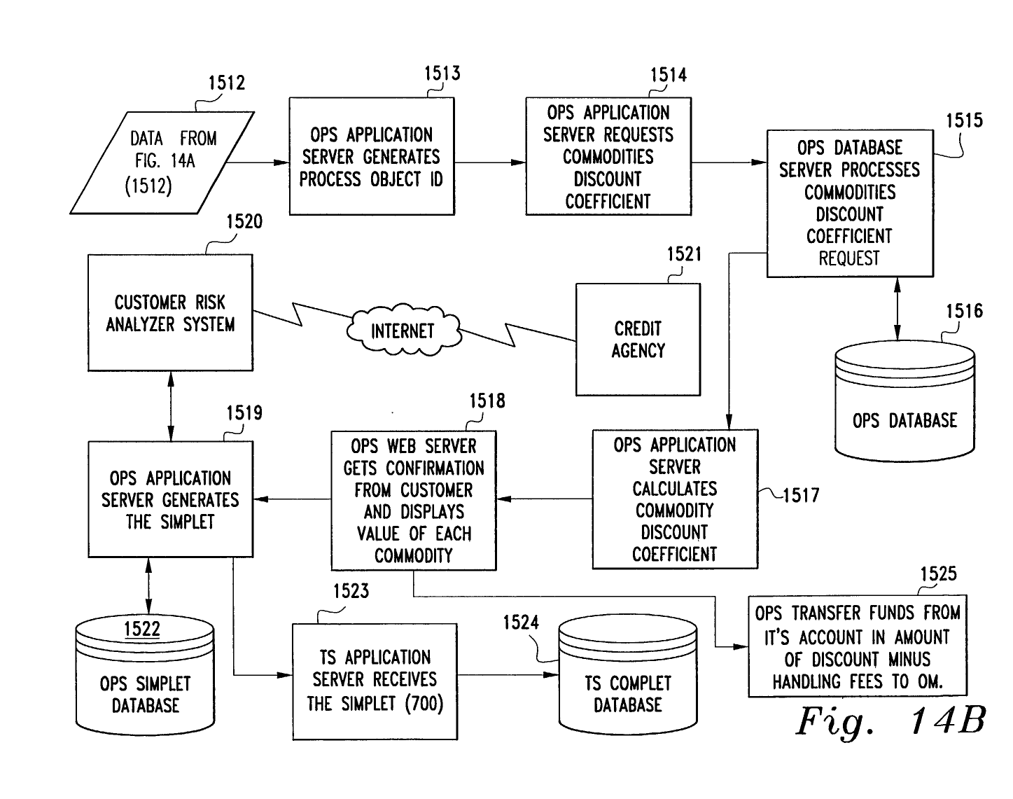

FIGS. 14A-14B illustrate the Retail Kiosk data exchange process. The process starts with the buyer selecting a product to purchase at the Retail Kiosk 1501 and selecting a discount at the Kiosk 1502. The Kiosk retrieves and displays 1503 commodity categories names, the customer selecting commodity categories and the time period commitment 1504, from local memory cache (in case of PC-based Kiosk implementation) or from TS Remote server or from merchant's central application server 1505. In case of TS Remote server data retrieval, the TS server is connected to the OPS database and retrieves commodity category list and commodity providers names for each category from OPS database. In the case where Retail Kiosk uses merchant's application server, the Kiosk connects to the merchant's server, which in its turn connects to the merchant's database to retrieve commodities data.

In all cases, after buyer selects commodity categories, and % of each of the commodity categories, TS application server proceeds with processing the data, displaying the commitment value to the customer 1506. If the buyer does not commit to the purchase 1507, the purchasing process is terminated 1508. Otherwise, customer data is sent to the OPS 1509, which generates an object ID 1510 and Commodity Coefficient 1511, continuing with converting buyer's/purchase data into SIMPLET objects, receiving the buyer's digital signature, recording the SIMPLET in the COMPLET database, and transferring funds to the original merchant as described in steps 1512-1525 of FIG. 14B and as set forth previously.

FIG. 15 illustrates the architecture of a Universal Portal with TS Implementation that complements FIG. 4A. In this drawing Portal (or Mall) web site 1602 has multiple merchants'stores 1601A, 1601B connected via Internet or running on Portals application servers with Portal/Mall database stores necessary information for purchases 1603. In this implementation, multiple Portal merchants may use same TS. When buyer purchases items/services from a number of merchants on the Portal, s/he uses same TS system, i.e., the Portal 1602 accesses the OPS web server 1606, security server 1607, and application server 1608 to get to the OPS Process System database 1609 through the Internet, Virtual Private Network, or Private Network. Similarly, multiple Commodity Providers 1604A, 1605A with their respective Commodity Provider databases 1604B, 1605B are connected to the same network, as is the Trading System with its web server 1610, security server 1611, application server 1612 and TS system database 1613.

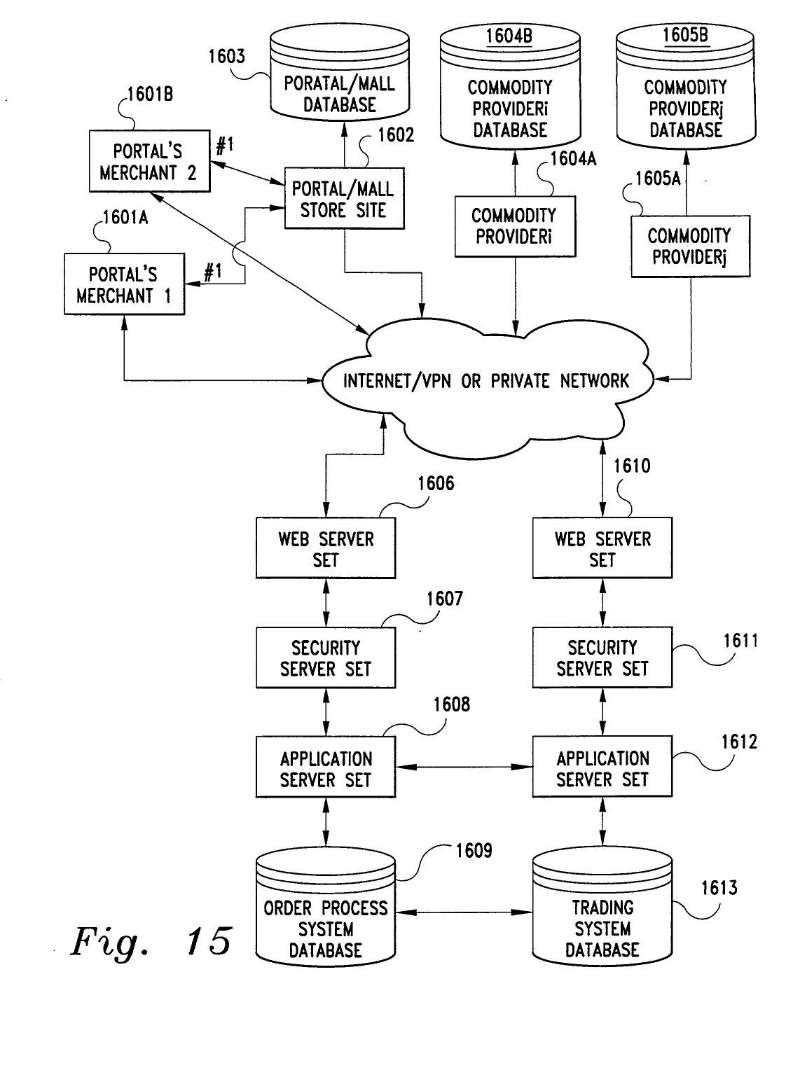

FIG. 16 illustrates the double credit transfer of credit debt, or a credit debt guarantee, in the amount of buyer-selected discount from the buyer to TS Owner site and then to multiple Commodity Providers (bidders). After the original merchant sends buyer's credit information, purchase data and buyer's personal data over the secured (SSL) connection to the OPS part of TS system 1700, OPS processes and records buyer's information 1701 in the OPS databases 1702, 1703. OPS server presents to the buyer an agreement to digitally sign 1704 or to present a digital certificate verified by a third party (for example VeriSign) 1705. Buyer agrees to the credit debt of discount value transfer, interest free to the TS online account. Buyer also agrees to split credit debt into multiple credit debts (number equal to number of buyer-selected commodity categories). Each value of credit debt is proportional to the buyer-selected ratio of the particular commodity category purchase amount to the whole commodity purchase amount committed by the buyer.

Buyer digitally signs the agreement 1706 to transfer each portion of the debt to Commodity Bidder in particular commodity category that will win the bid on the COMPLET containing that particular buyer's contract. If buyer fails to sign, the transaction is terminated 1713. The credit debt is a guarantee of the compliance by the buyer with the conditions of the agreement. The credit debt will be retired over the time, i.e., the credit debt is cancelled provided that the buyer makes the purchases from the Commodity Provider(s) over the time period of the contract, as agreed. The credit debt will be covered with purchases of the goods/services from the commodity provider in the selected category at the buyer's convenience over agreed upon time period.

The OPS web server captures the signed agreement and transfers it to the OPS application server 1707, where it is stored 1708 in the OPS Accounts database 1714. OPS includes the buyer's agreement in the SIMPLET which is transferred to the Trading System 1709, where the SIMPLET is bundled into a COMPLET and auctioned 1710. TS signs an agreement with the Bid Winner 1711 and transfers the debt to the Commodity Bidder's Account. The transaction is recorded in the TS Bidding Archive database 1712, and the process of transferring the debt/guarantee is terminated 1713.

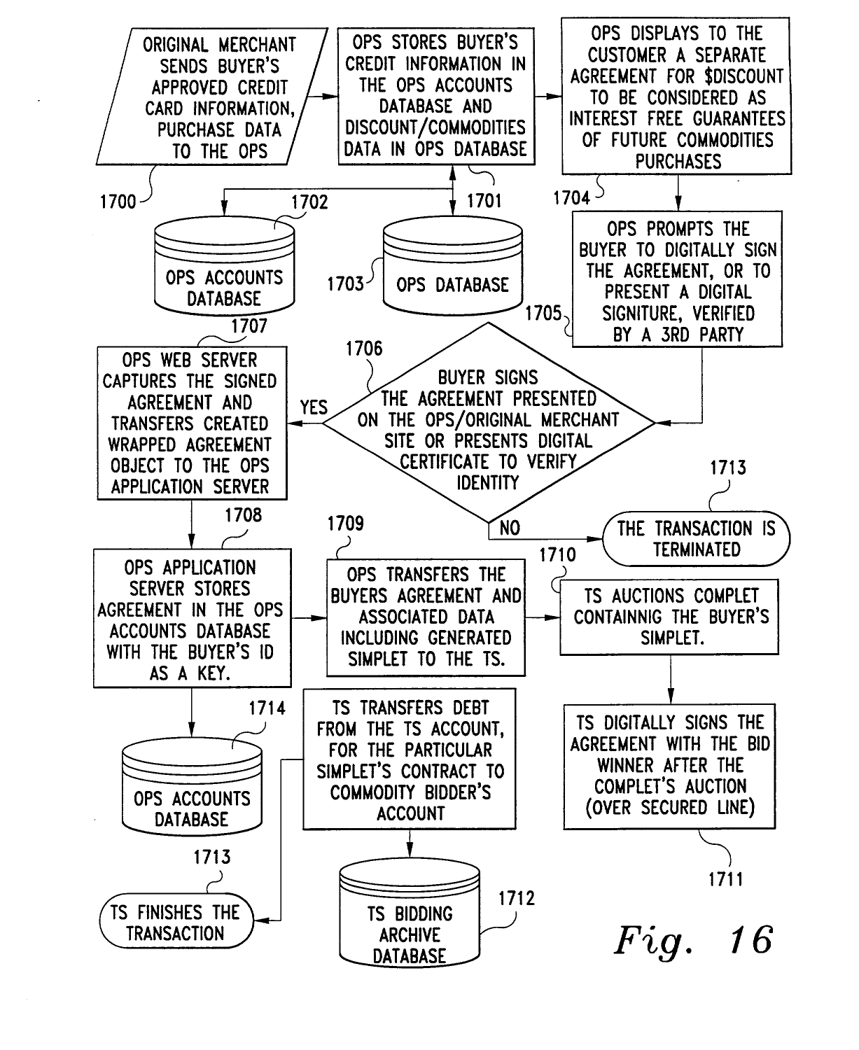

FIG. 17 illustrates the architecture of the TS auctioning COMPLET objects to the commodity providers 1804, 1805, and their associated databases 1804 and 1805, which are associated with the commodity market exchange 1814 and its associated database 1815. Buyers that use the system are business buyers. TS system creates an interface with a Commodity Market Exchange (for example, metals exchange) 1814. The difference between common Internet-based market exchanges and TS mediated commodity purchases is that, in a common market exchange, buyers purchase spot commodities, paying for a certain amount of goods/services at the time of purchase. TS will have a link at the Exchange web site. Thus Commodity sellers (Bidders) associated with the Exchange may select the TS method of payments over period of time while selling their Commodities at a better price than the Exchange average bid price. Thus, the Commodity Providers 1804 and Commodities Market Exchange 1814 are connected through the network to the OPS system database 1809 through the OPS web sever 1806, security server 1807, and application server 1808, and to the TS system database 1813 through the TS web server 1810, security server 1811, and application sever 1812, as are the merchant application server 1802 and its associated merchant database 1803.

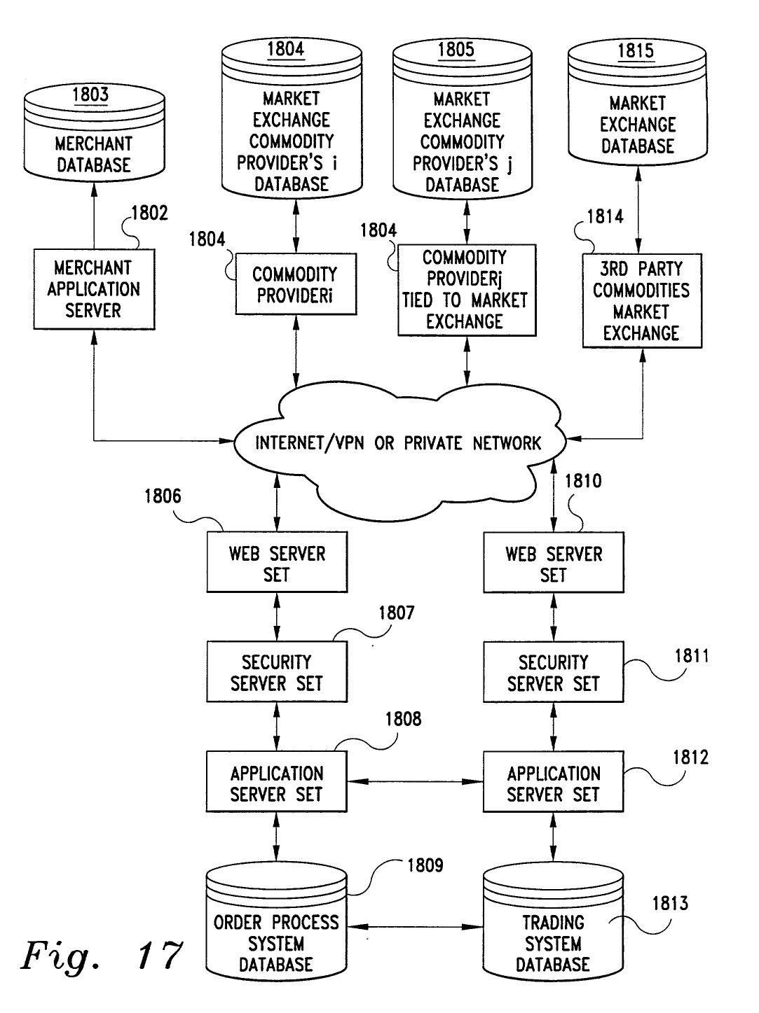

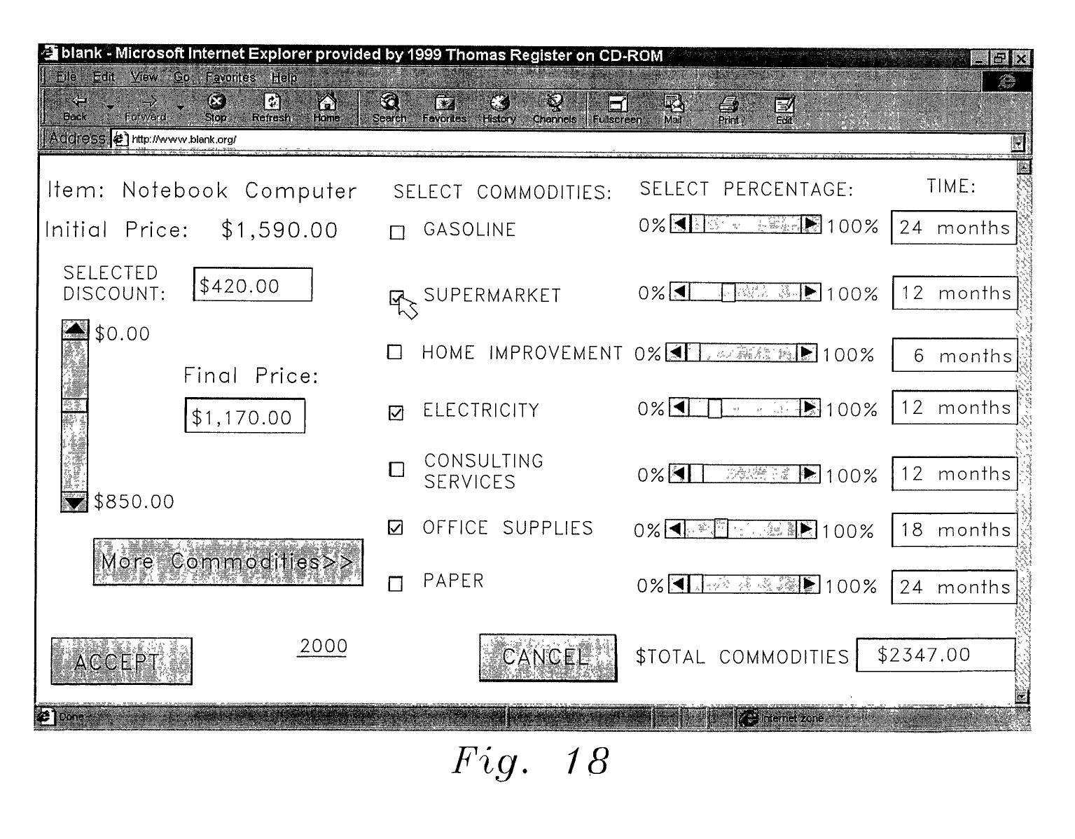

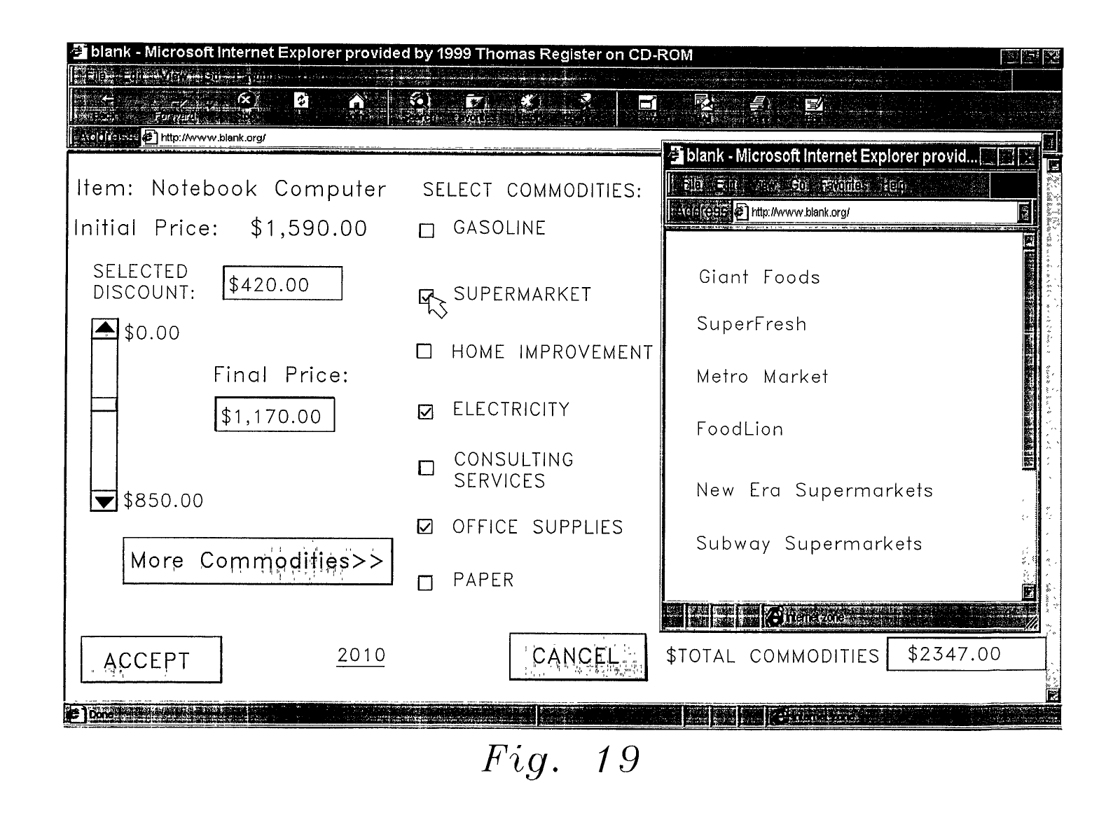

FIGS. 18-20 are illustrations of the browser-enabled interface of the Discount Interface as presented to the original buyers. It includes interface for business buyers 2020, as shown in FIG. 20, and for a consumer buyer, as shown in FIGS. 18-19. Referring to the screenshot 2000 in FIG. 18, the interface displays the Initial Price of the item/service selected by the buyer. Here it is illustrated with a Notebook Computer as the item selected by the buyer. Buyer may select a discount (absolute value) as illustrated on the left. Buyer selected discount $420 in the limits defined by the TS. Here TS determined that the maximum discount it can offer $850.00. To cover the discount buyer has to select commodity categories on the right. Here, buyer selected Supermarket, Electricity and Office Supplies categories. Time payoff period that buyer may select in certain cases is shown on the left. Note, that time limits for all categories have certain default values. Total monetary amount of commodity purchases that buyer has to do is shown in the right low corner of the interface. In this case, it is $2347.00 of commodities purchase to do over time. Buyer can accept (Accept command button) or Cancel (cancel command button) the chosen TS selections.

FIG. 19 is a screenshot 2010 which shows the list of commodity providers for a particular category and location that currently participate in the TS in a frame at the right of the display area. A buyer looking on the list can decide if he or she agrees to accept commodity items/services from any of them.

FIG. 20 illustrates the discount Interface for the business buyer. Buyer purchases 30 Notebook Computers and can select a discount shown on the left.

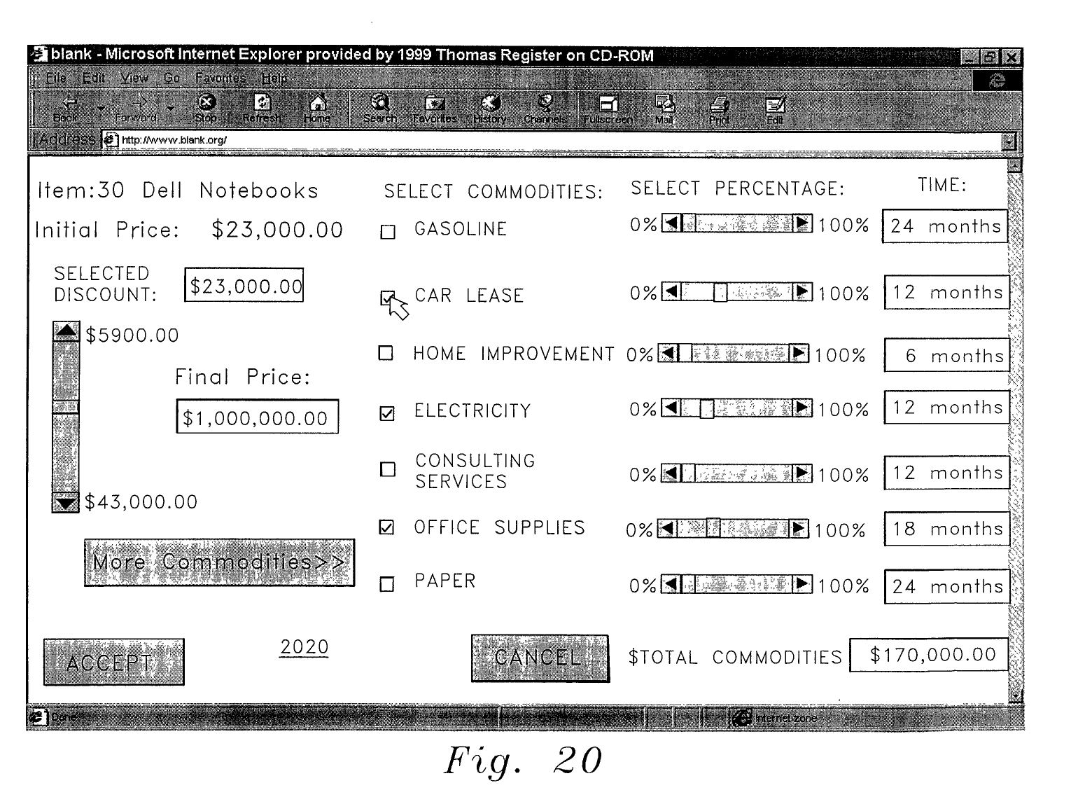

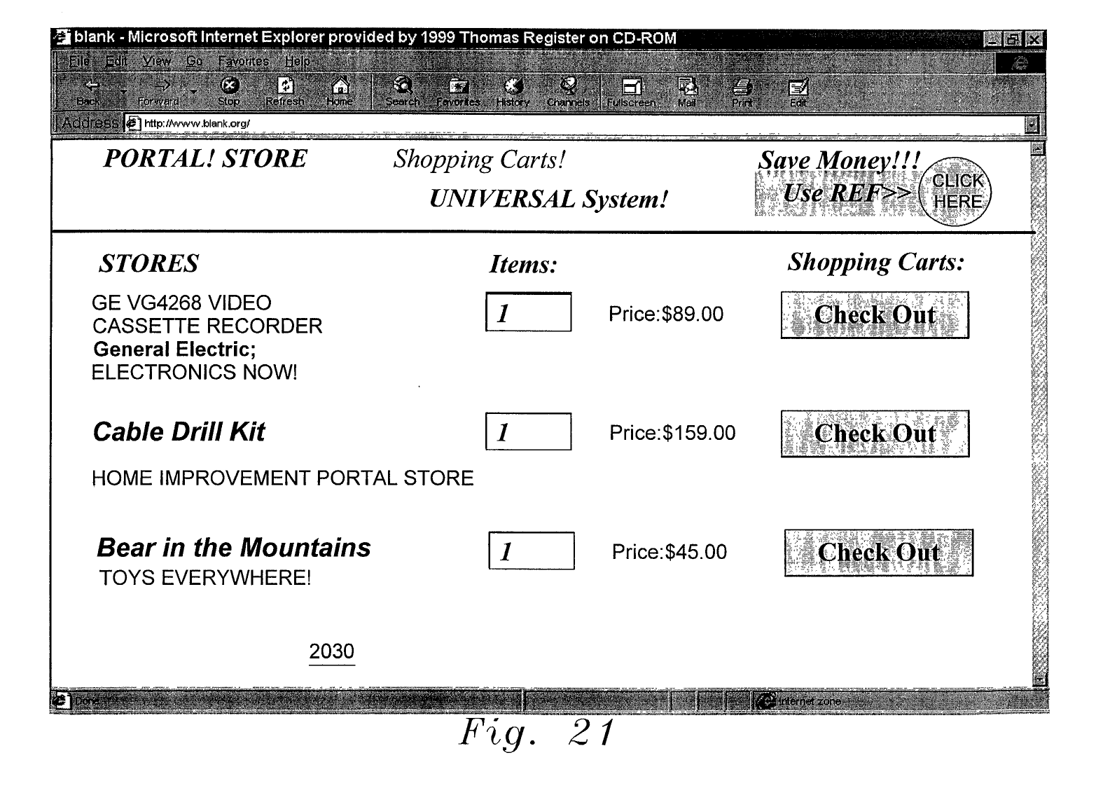

FIGS. 21-22 illustrate a particular TS implementation for Internet portal Stores and Internet Malls (e-malls). As shown in screen 2030 in FIG. 21, Buyer selects multiple items from multiple Portal Merchants and proceeds to the Shopping Carts as shown in screen 2040 in FIG. 22. Buyer may look at TS system work. The TS System link is shown on the Shopping Cart frame in the upper right corner of the display in FIG. 22. After Buyer proceeds with purchases for particular Shopping Cart as shown in FIG. 22, it may use the TS system. The interface at the particular merchant site is accessed by clicking on the TS link in the reloaded upper frame, and will be the same as in FIGS. 18-19.

FIG. 23 illustrates a Trading interface 2050 for the Commodity Bidders (manual implementation, when person enters bid manually). It shows all relevant to trade information such as location, bids information, total worth of COMPLET, number of contracts in the said COMPLET, etc. Bidder can make the bid and start participating in the auction. Bidder also can select the bid type (Market is the default Bid Type).

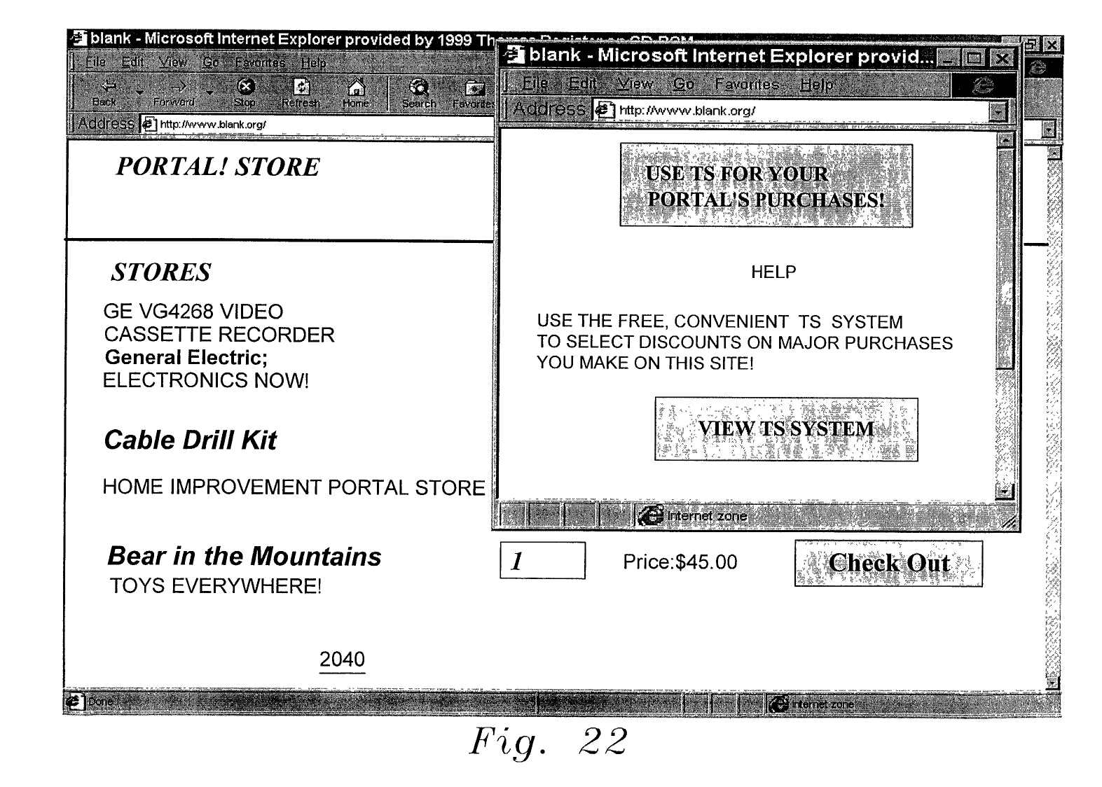

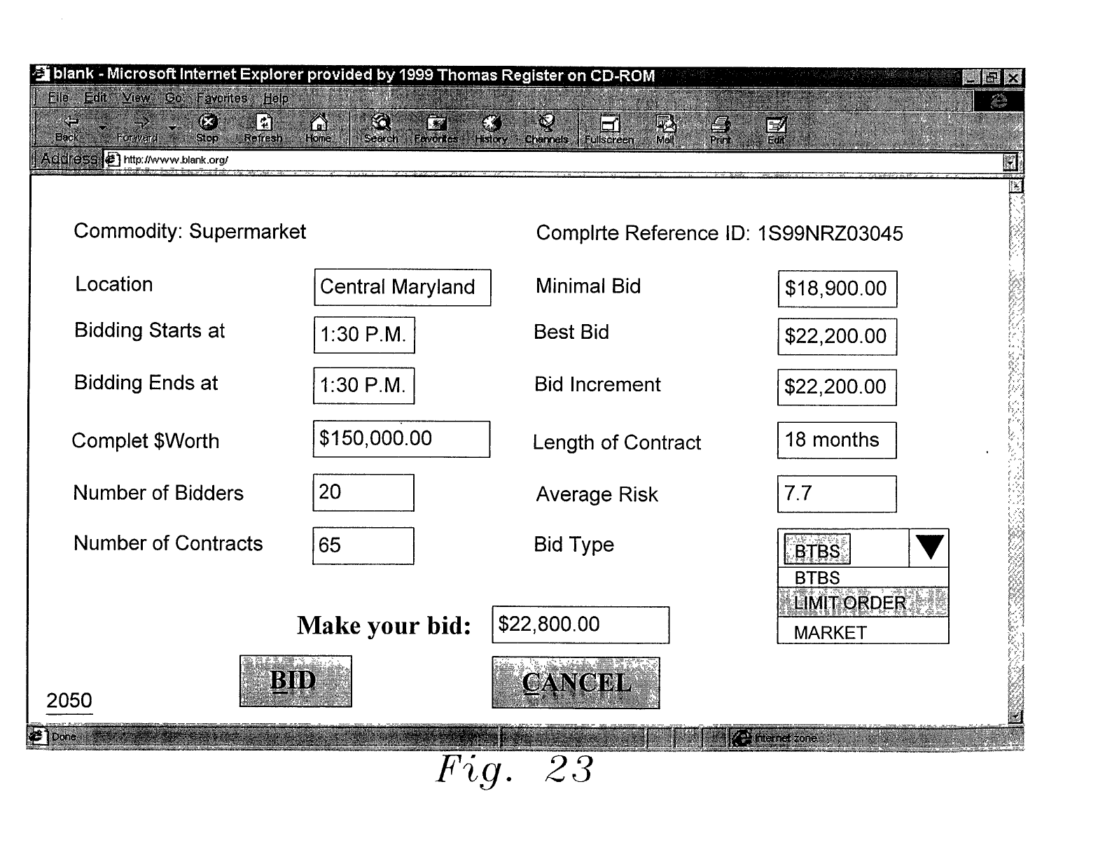

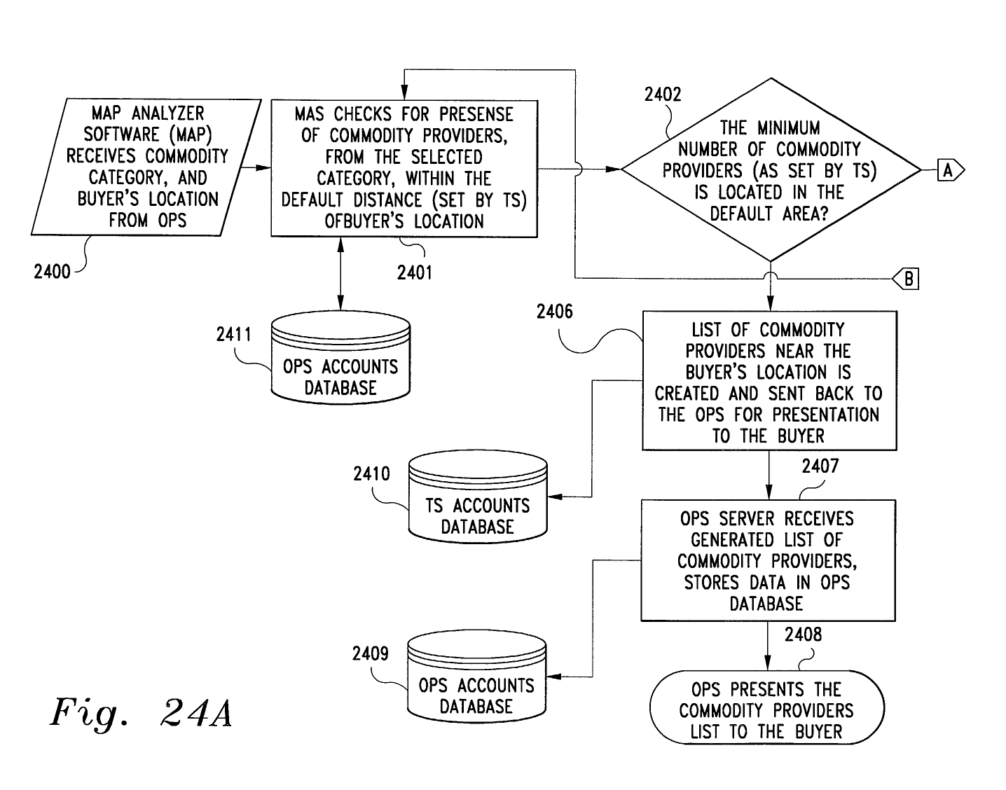

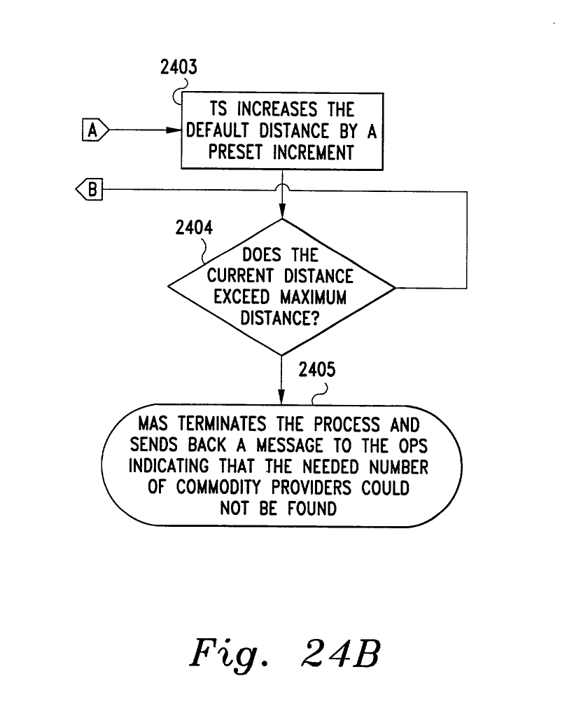

FIGS. 24A-24B show the steps 2400 through 2411 of an algorithm used by OPS to limit the list of the Commodity Providers presented to the buyer when the nature of the Commodity requires that the Commodity Providers be restricted to a particular geographical locality. The steps are self-explanatory and will not be elaborated further.

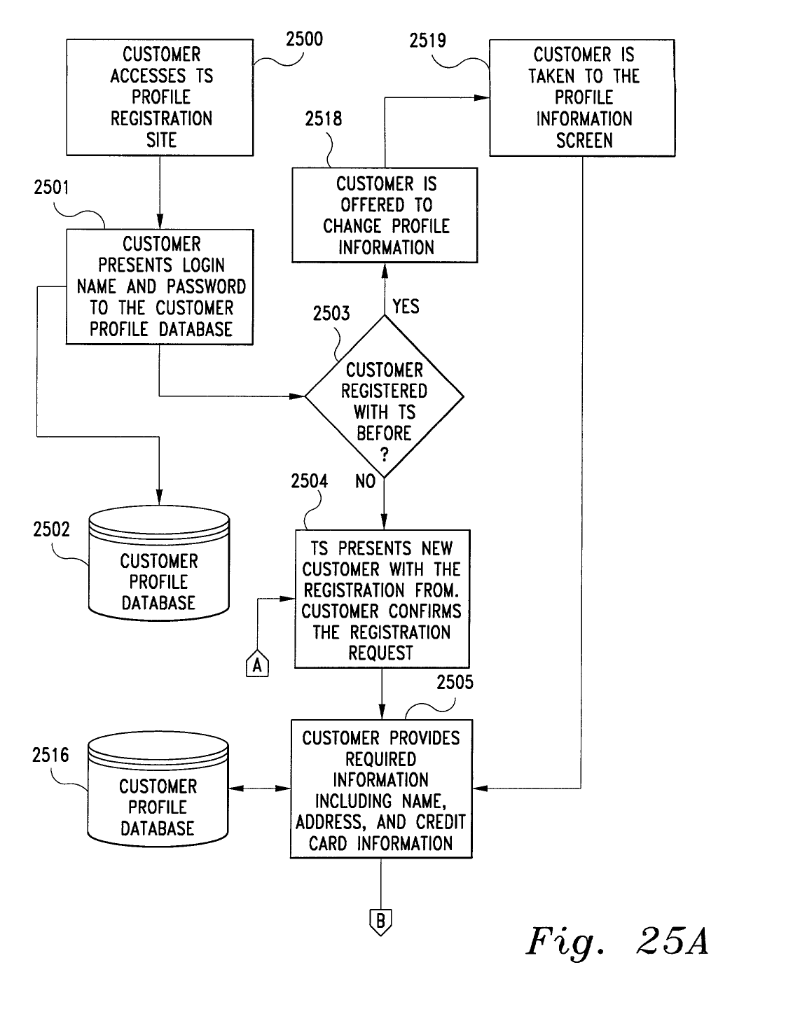

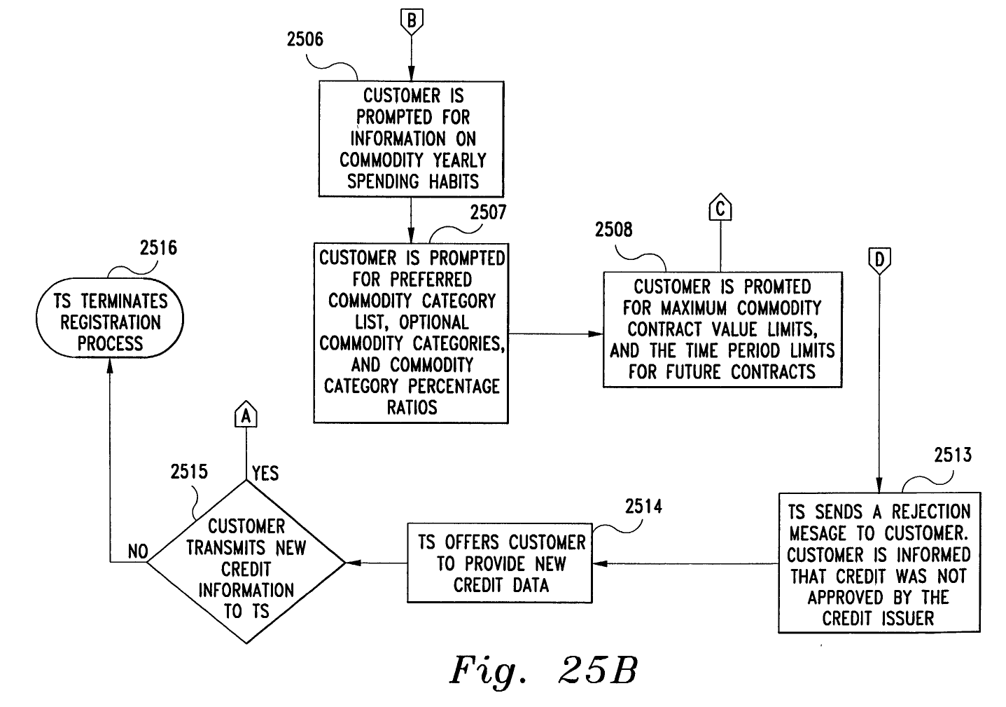

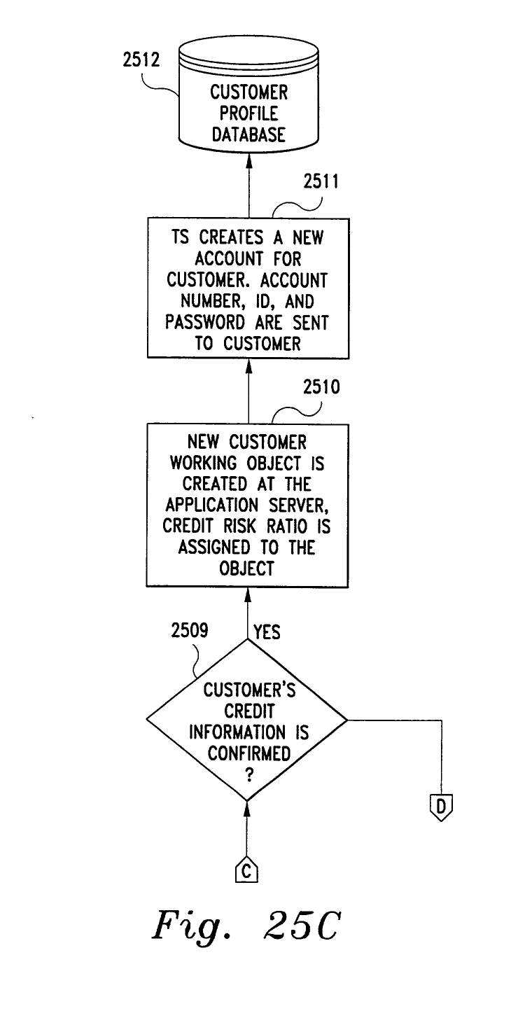

FIGS. 25A-25C show the steps 2500 through 2516 in registering a Commodity Provider with the Trading System. The steps are self-explanatory and will not be elaborated further.

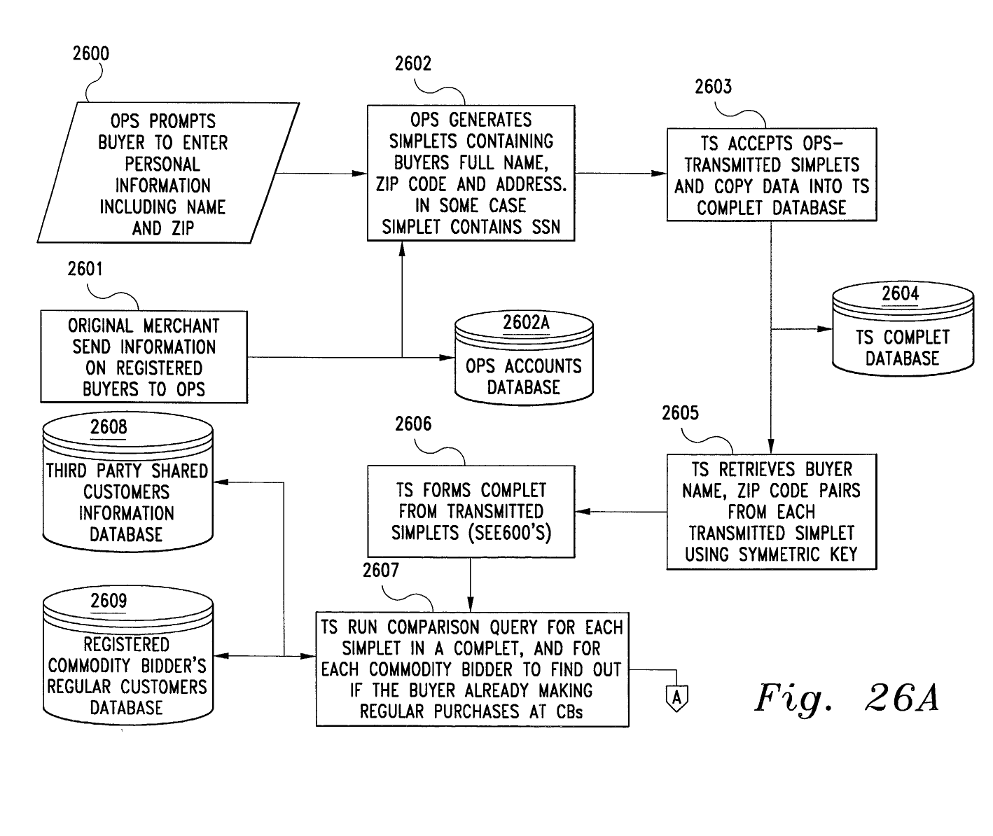

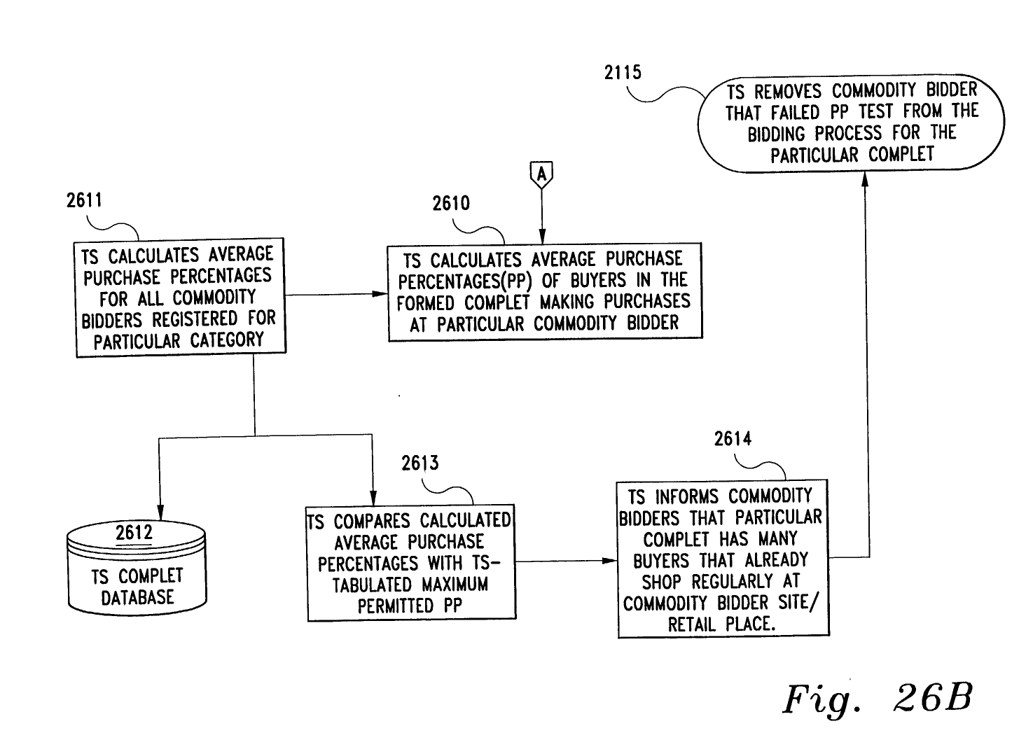

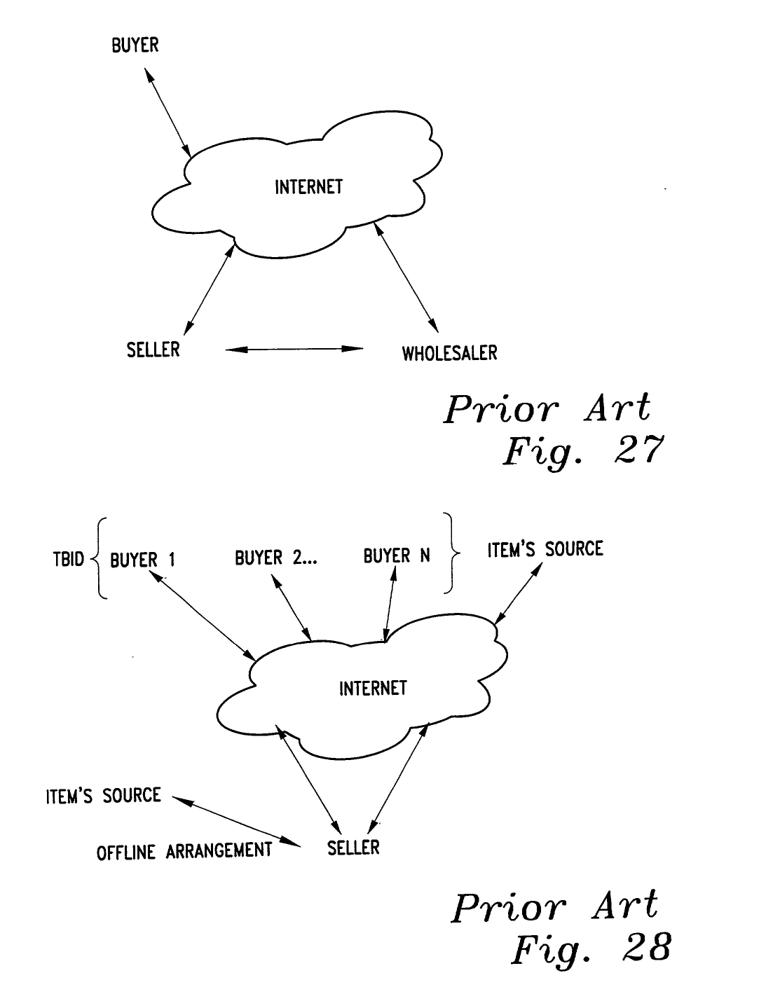

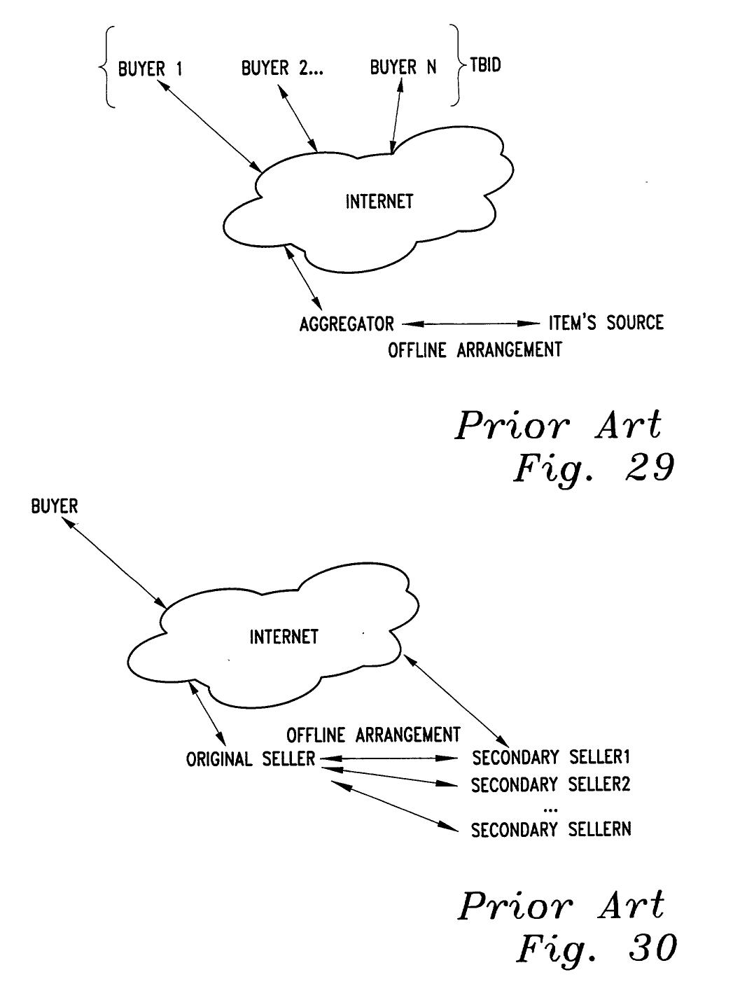

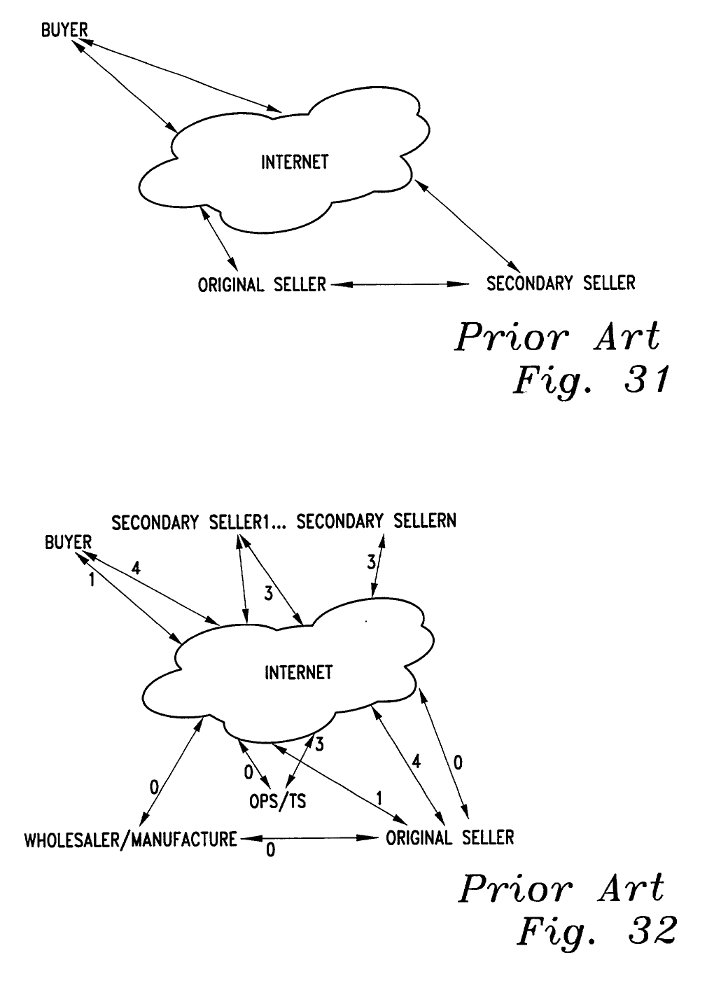

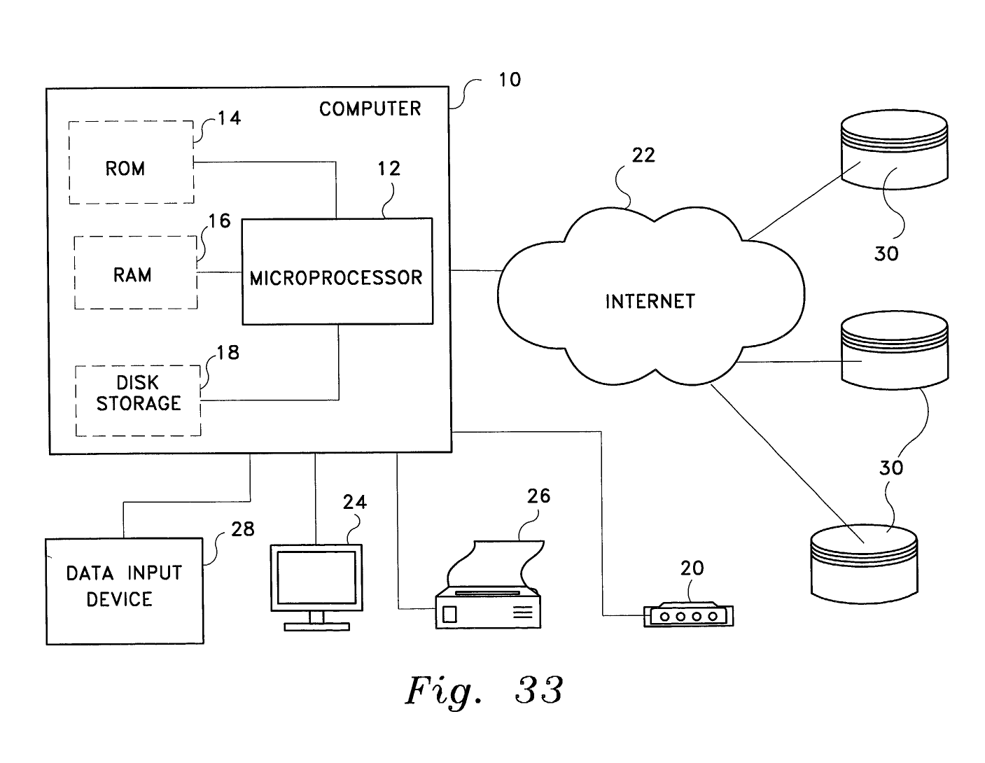

FIGS. 26A-26B show the steps 2600 through 2614 is screening Commodity Bidders prior to auctioning a COMPLET. The steps are self-explanatory and will not be elaborated further.

It is to be understood that the present invention is not limited to the sole embodiments described above, but encompasses any and all embodiments within the scope of the following claims.

We claim:

1. A computerized system for providing an original buyer with a discount on the purchase of goods, services or the advance of credit from an original merchant, said computerized system comprising:
a) at least one server computer having a processor, an area of main memory for executing program code under the direction of the processor, and a disk storage device for storing data and program code;
b) a data communications device linking said server computer to a distributed network; and
c) computer program code stored in said disk storage device and executing in main memory under the direction of said processor, the computer program including:
i) order processing system means for interfacing with the original buyer in order to receive the buyer's request for a discount and the buyer's contractual commitment to purchase goods and services from one or more commodity providers over an extended period of time and for advancing the discount to the original merchant; and
ii) trading system means for creating a bundle of a plurality of original buyer's contractual commitments for purchase of goods and services over an extended period of time grouped by category, buyer's location, and time period, and subsequently auctioning the bundles to commodity providers over the distributed network.

2. The computerized system according to claim 1, wherein said order processing system further comprises means for presenting the original buyer with a plurality of categories of goods and services for purchase over an extended period of time in a secondary tie-in sale and for receiving the buyer's election of one or more of the categories.

3. The computerized system according to claim 1, wherein said order processing system further comprises means for calculating a sum that a commodity provider will pay in exchange for the buyer's contractual commitment for purchase of goods and services over the extended period of time for each category elected by the buyer and for allocating the sums so calculated between the categories elected by the buyer in order to cover the discount requested by the buyer.

4. The computerized system according to claim 1, wherein said order processing system further comprises means for creating a simple trade object implemented as a software object, the software object containing buyer identification, location, a single category of goods and services elected for purchase by the buyer, the dollar amount of the buyer's commitment, and the time period for making the purchases elected by the buyer.

5. The computerized system according to claim 4, wherein said order processing system further comprises means for obtaining a credit check on the original buyer from a third party and evaluating the original buyer's credit risk, said simple trade object implemented as a software object including the credit check and evaluation of the credit risk.

6. The computerized system according to claim 4, wherein said trading system further comprises means for creating a combined multiple software object which includes a plurality of simple trade objects implemented as a software object relating to a plurality of original buyers and being grouped by the category of goods and services and the location of the buyers.

7. The computerized system according to claim 1, wherein said data communications device links said server computer to the Internet.

8. The computerized system according to claim 1, wherein said data communications device links said server computer to a virtual private network.

9. The computerized system according to claim 1, wherein said data communications device is capable of wireless digital data communications.

10. The computerized system according to claim 1, wherein said data communications device is capable of receiving data by cellular telephone.

11. The computerized system according to claim 1, further comprising a computer workstation located in a kiosk at a brick and mortar store, the computer workstation being linked to the distributed network and having browser-enabled means for communicating with said order processing system in order to provide a user interface for the original buyer.

12. The computerized system according to claim 1, wherein said order processing system further comprises means for receiving information concerning the original buyer from the original merchant.

13. The computerized system according to claim 1, wherein said order processing system further comprises means for soliciting and receiving buyer's authority to charge a credit instrument of the buyer as guarantee for buyer's fulfillment of buyer's contractual commitment.

14. A computer program product that includes a medium readable by a processor, the medium having stored thereon a set of instructions for making and brokering contracts electronically, comprising:
a) a first sequence of instructions which, when executed by the processor, causes said processor to provide an electronic interface over a distributed network for accepting an original buyer's request for a discount to complete the purchase of goods, services, or capital from an original merchant;
b) a second sequence of instructions which, when executed by the processor, causes said processor to display a plurality of goods and services on said electronic interface and to permit the original buyer to select one or more categories of goods and services for purchase and to enter a period of time to make the purchases;
c) a third sequence of instructions which, when executed by the processor, causes said processor to calculate a sum that a commodity provider will pay in exchange for the buyer's contractual commitment for purchase of goods and services over the extended period of time for each category elected by the buyer, allocate the sums so calculated between the categories elected by the buyer in order to cover the discount requested by the buyer, and display the sums to the buyer over said interface;
d) a fourth sequence of instructions which, when executed by the processor, causes said processor to solicit and obtain the buyer's digital signature to a contractual commitment to purchase the goods and services in the elected categories over an extended period of time in exchange for payment of the discount requested by buyer.

15. The computer program product according to claim 14, further comprising a fifth sequence of instructions which, when executed by the processor, causes said processor to create a SIMPLET software object containing buyer identification, location, a single category of goods and services elected for purchase by the buyer, the dollar amount of the buyer's commitment, and the time period for making the purchases elected by the buyer for each category of goods elected by the buyer.

16. The computer program product according to claim 15, further comprising a sixth sequence of instructions which, when executed by the processor, creates a COMPLET software object containing a group of SIMPLET objects relating to one or more original buyers, the group of SIMPLET objects relating to a single category of goods and grouped by location, and to calculate a COMPLET dollar value equal to the sum of the buyer discounts allocable to said plurality of SIMPLETS and a processing fee.

17. The computer program product according to claim 16, further comprising a seventh sequence of instructions which, when executed by the processor, causes said processor to provide an electronic interface over a distributed network for offering said COMPLET for auction with a minimum bid equal to the COMPLET value, to receive a plurality of bids from commodity providers, to award the COMPLET to the highest bid of said plurality of bids, and to transmit all information contained in said COMPLET to the highest bid after payment of the highest bid.

18. A computerized method for making and brokering contracts over a distributed network, comprising the steps of:
(a) providing at least one server computer publishing an interface on the distributed network offering payment of a discount requested by an original buyer to an original merchant for an original transaction involving the purchase of a product, a service, or the advancement of capital;
(b) electronically receiving a buyer's request for a discount and an election of at least one category of a tie-in goods and services for purchase over an extended period of time in exchange for advancement of the discount;
(c) calculating a sum that a commodity provider will pay in exchange for the buyer's contractual commitment for purchase of goods and services over the extended period of time for each category elected by the buyer;
(d) allocating the sums so calculated between the categories elected by the buyer in order to cover the discount requested by the buyer;
(e) displaying the sums so calculated and allocated to the original buyer over the distributed network;
(f) soliciting and receiving the buyer's digital signature to a contractual commitment to purchase goods and services in the calculated and allocated sums over the time periods elected in exchange for the discount;
(g) paying the discount requested by the buyer to the original merchant.

19. The computerized method according to claim 18, further comprising the steps of:
(h) for each category of tie-in goods and services elected by the buyer, creating a SIMPLET software object at least identifying the buyer, the buyer's location, the category of goods and services, the extended period of time for purchase of the goods and services, and the total dollar amount of goods and services to be purchased;
(i) repeating steps (b) through (h) for a plurality of original buyers;
(j) creating a COMPLET software object containing a plurality of SIMPLET objects grouped by category of goods and services and location, each COMPLET including a COMPLET dollar value equal to the sum of the discounts allocable to each of said plurality of simplet objects plus a processing fee;
(k) electronically auctioning said COMPLET to commodity providers over the distributed network;
(l) awarding said COMPLET to a highest bidder;
(m) receiving payment from the highest bidder; and
(n) assigning all buyers' contractual commitments to the highest bidder.

20. The computerized system according to claim 19, further comprising the step of screening all commodity providers by location before the step of auctioning said COMPLET.
